(19) United States
(12) Patent Application Publication
(10) Pub. No.: US 2024/0203718 A1
(43) Pub. Date: Jun. 20, 2024

(54) INTERFACE ION GUIDE

(71) Applicant: Thermo Fisher Scientific (Bremen) GmbH, Bremen (DE)

(72) Inventors: Ralf Günter HARTMER, Bremen (DE); Dmitry GRINFELD, Bremen (DE); Mathias GERSMANN, Bremen (DE); Frederik BUSSE, Bremen (DE)

(73) Assignee: Thermo Fisher Scientific (Bremen) GmbH, Bremen (DE)

(21) Appl. No.: 18/537,674

(22) Filed: Dec. 12, 2023

(30) Foreign Application Priority Data
Dec. 16, 2022 (GB) 2219060.7

(51) Int. Cl. H01J 49/06

(52) U.S. Cl. CPC H01J 49/062

(57) ABSTRACT

An interface ion guide for transmitting ions from a stacked ring ion guide (SRIG) to a multipole ion guide, the interface ion guide having a longitudinal axis and comprising n set(s) of plate electrode(s), wherein n≥1; each set of plate electrodes comprising two or more plate electrodes; each plate electrode comprising a plate, the plate comprising a planar surface and an aperture formed in the planar surface for transmission of ions therethrough along the longitudinal axis, wherein the plate of each plate electrode is spaced apart from the plate of an adjacent plate electrode along the longitudinal axis; each plate electrode further comprising one or more protrusions, wherein each protrusion extends at a respective non-zero angle to the planar surface, wherein the protrusion(s) of each set of plate electrodes are configured to generate an RF multipole field to focus ions towards the longitudinal axis. A method of transmitting ions from a stacked ring ion guide (SRIG) to a multipole ion guide using the interface ion guide is provided.

### FIELD

The present invention relates to an interface ion guide for transmitting ions from a stacked ring ion guide (SRIG) to a multipole ion guide. The present invention also relates to an ion transfer assembly configured to receive ions from an ion source and transfer ions to a downstream RF multipole ion guide and/or mass analyser and a method of transmitting ions from a stacked ring ion guide (SRIG) to a multipole ion guide.

### BACKGROUND

Mass spectrometers typically generate ions at atmospheric pressure but analyse ions at much lower pressures under high vacuum. Typically, after ion generation, the ions enter a stacked ring ion guide (SRIG) which is configured to receive and transmit ions at high pressures. These devices are well known to improve ion transmission and instrument robustness (i.e. contamination with dielectric particles) compared to simpler transfer optics. The ions are then transferred to a downstream multipole operating at a much lower pressure and then finally to a mass analyser.

Stacked ring ion guides have a plurality of plates typically spaced equidistantly apart and of equal thickness, each plate having an aperture that is typically circular. Typically, the plate electrodes have a thickness of ≤1 mm. Such a low thickness avoids unintended loss of ions at the surface of the plate electrode where the electrical potential gradient is weak. Typically, the distance between adjacent plates is on the order of the thickness of the conducting plates. This arrangement yields a high ion acceptance area while keeping the aperture restricting the gas flow small. Adjacent plates have opposite RF polarities. In use, the RF field generated forces the ions radially inward but does not drive the ions axially. Usually, a single DC-only electrode is provided at the outlet of the electrode to drive ions along the axis of the SRIG. In some arrangements, the SRIG is configured as a funnel employing plates having apertures that decrease in diameter such that the aperture at the outlet has a diameter of a few millimeters. The SRIG funnel therefore focusses the ion beam as it is transmitted therethrough. Ion funnels have been shown to be very effective in collecting the ions, significantly increasing the transmission over a simple stacked ring ion guide interface [Kelly et al, Mass Spectrometry Reviews 2010 29 (2): 294-312.].

SRIG funnels typically suffer from significant ion loss at the exit aperture where ion density is largest and where the ratio of the aperture diameter to inter-electrode distance is smallest. Small apertures in the plate electrodes of the SRIG impose an upper limit on the allowed radial excitation of ion oscillation, which leads to a cutoff of low m/z ions. Smaller apertures also cause the axial trapping potential between the plates to be more pronounced, which may lead to transient trapping and ion fragmentation. For ion beams close to or above the space charge limit of typically one or more nA, these effects are compounded as the ions spread out radially towards the electrodes of the SRIG, especially in regions of ion focus such as the radial wells.

As the SRIG is at a higher pressure than the downstream multipole, the SRIG is typically provided in a separate, differentially pumped vacuum chamber from that of the downstream multipole. The resulting gas fluidic motion between these chambers helps to overcome ion confinement near the exit aperture.

To improve ion transmission, and to increase the space charge limit of the device, many designs utilize an axial potential gradient to push ions towards the SRIG exit. DC electrodes may be interleaved within the RF plates, or an individual DC offset may be applied to each of the RF plates directly. The SRIG exit aperture typically functions as both the separation between the two differentially pumped vacuum chambers and as the DC-only aperture separating the SRIG from the subsequent RF multipole. Usually an attractive potential of a few volts is applied to this aperture to improve ion transmission.

In addition to the described transmission losses, small SRIG apertures tend to suffer from contamination. If charged particles or neutrals continuously impact the surface of an electrode (particularly at the exit of the SRIG) and the remaining neutrals are not removed, i.e. if the vapor pressure of the sampled dielectric particles is too low, then the electrode will be covered with dielectric chemical residues. As the surface becomes gradually more dielectric, further ion impacts lead to a buildup of charge which will distort the local electric potential. This phenomenon of accumulation of charged particles on contaminated electrode surfaces is referred to as “charging” and is very difficult to control. Cleaning of the contaminated parts of the ion guide typically requires venting of the instrument and consequently is very time-consuming.

The axial DC field within the SRIG as well as the attractive DC-voltage applied to the last DC electrode is a common way to prevent the start of “charging” by increasing ion transmission and so reducing ion deposition on the electrode surface. However, when applying DC gradients in regions with pressures above 0.005 mbar, such as in an SRIG, collisions between the accelerated charged particles and the background gas may lead to collisional activation of the charged analyte molecules and to unintended fragmentation either immediately or further downstream of the ion guide.

Another way to prevent contamination is to minimize the ion beam intensity. However, for the purpose of having a sensitive mass analyzer, it is preferable to increase the ion beam intensity to its maximum allowed value before the surface gets contaminated due to disturbance of the ion beam. Another, approach to overcome charging of already contaminated surfaces of an electrode, is the discharging with charged particles having the opposite ion polarity. However, this approach is very ineffective and only temporary. Discharging of contaminated surfaces is difficult to control because the area of contamination is typically not known and efforts in balancing the right number of charged particle for discharging. If the discharging of the contaminated surface is incomplete, then the ion transmission is still suppressed. If too many charged particles are utilized for discharging, then the contaminated area weakens the ion transmissions for the opposite polarity.

Many applications require that the ions collected within an SRIG are transferred to an ion guide with quadrupolar field geometry, e.g. for detecting or filtering ions based on their m/z ratio. However, the radial trapping potential of an SRIG is rather shallow close to the ion guide axis with steep barriers close to the RF electrodes, while that of a quadrupole varies slowly at the edges but tightly focuses ions to the ion guide center, causing a mismatch between the emitted beam profile and the one a quadrupole accepts. Several approaches that aim to prevent ion loss due to such a mismatch when transmitting ions from a SRIG to a downstream RF multipole are known.

For example, U.S. Pat. No. 9,123,517 describes a multipole ion guide employing rods arranged about a longitudinal axis that may generate a regular RF multipole field having a certain order that can be varied by varying the number of rods. It describes that higher order field results in a wider acceptance area.

U.S. Pat. No. 7,569,811 describes an ion guide having groups of rods generating a multipole RF field where rods closer to the outlet have a smaller distance to the longitudinal axis and smaller radius where the distance and radius are reduced in proportion with each other.

U.S. Pat. No. 8,193,489 describes a multipole ion guide having rods disposed about an axis where the end of the rod proximal to the outlet is closer to the longitudinal axis than the end of the rod proximal to the inlet thereby confining ions towards the longitudinal axis as they are transmitted from the inlet to the outlet.

U.S. Pat. No. 9,449,803 describes an ion guide that can transport ions through pressure-reducing stages where two RF fields are generated and superimposed, at least one of the RF fields being generated using rod electrodes where the number of rods is varied to vary the order of the RF field. It describes that the rods converge along the longitudinal axis.

U.S. Pat. No. 8,124,930 describes an ion guide using stacked rings where the order of the field may be varied by varying the spacing between the rings.

U.S. Pat. No. 7,391,021 describes RF ion guides having stacked aperture diaphragms having indentations extending in the plane of the plate where abutting portions of each diaphragm have an opposite polarity is applied thereto to generate a quadrupole RF field. The cross-over area between each portion is minimized to reduce capacitance.

### SUMMARY

In accordance with a first aspect of the present invention, there is provided an interface ion guide for transmitting ions from a stacked ring ion guide (SRIG) to a multipole ion guide, the interface ion guide having a longitudinal axis and comprising:
n set(s) of plate electrode(s), wherein n≥1;
each set of plate electrodes comprising two or more plate electrodes;
each plate electrode comprising a plate, the plate comprising a planar surface and an aperture formed in the planar surface for transmission of ions therethrough along the longitudinal axis, wherein the plate of each plate electrode is spaced apart from the plate of an adjacent plate electrode along the longitudinal axis;
each plate electrode further comprising one or more protrusions extending at a non-zero angle to the planar surface, wherein the protrusions of each set of plate electrodes are configured to generate an RF multipole field to focus ions towards the longitudinal axis.

In this first aspect of the invention, each set of plate electrodes has at least two plate electrodes, each plate electrode having one or more protrusions. Therefore, each set of plate electrodes necessarily has at least two protrusions, the protrusions being part of the plate electrodes within each set. The protrusions within each set of plate electrodes are configured to generate the RF multipole field to focus ions towards the longitudinal axis.

In the sense of the present invention, the term SRIG includes not only ion guides having only assembly(s) of stacked ring electrodes but also ion guides that would generate a similar electric field to an assembly of stacked ring electrodes in use. The term ring electrode refers to an electrode having an aperture therein for the transmission of ions therethrough. The ring electrode may optionally have a planar surface in which the aperture is formed. The term SRIG may refer to an assembly of electrodes where at least two of the electrodes are ring electrodes (where ring electrodes are electrodes having an aperture therein for the transmission of ions therethrough). The term SRIG includes an assembly of electrodes having other types of electrodes in addition to a ring electrode. The term SRIG includes assemblies where some of the electrodes, for example one or more of the upstream electrodes, have an open (e.g. half-ring) geometry and only the downstream electrodes have a closed (ring) shape. The term SRIG also includes an ion guide having ring electrodes of different diameters, such ion funnels. The term SRIG also includes assemblies having a dual-funnel design, or a geometry including two funnels with an ion mobility drift cell therebetween, such as those described in U.S. Pat. Nos. 7,888,635 and 8,324,565.

In contrast to the known ion guides discussed above, the interface ion guide of the claimed invention is configured similarly to a SRIG with plate electrodes where, in use, pairs of adjacent plate electrodes would have alternating RF voltages applied thereto, but it can generate an RF multipole field of a certain order due to protrusions extending at a non-zero angle to the planar surface of the plate. This is advantageous as the RF multipole field generated, particular its order and acceptance area, can be changed by changing the configuration of the protrusions while maintaining the sets of plate electrodes to have the same thickness and spacing as the plate electrodes of the SRIG. This enables a smoother transition from the SRIG to the interface ion guide. In particular, an RF voltage of the same amplitude and frequency can be applied to both the SRIG and interface ion guide mitigating the fringing fields and so avoiding the need for a DC electrode or significant gap having a reduced RF field therebetween. The absence of the DC electrode reduces charging and contamination of the final electrodes of the SRIG and also reduces fragmentation and activation of the ions. As the RF voltage applied to the SRIG and interface ion guide may be the same, a single RF transducer for electrically driving the SRIG and the interface ion guide may be employed.

The present invention therefore provides an interface ion guide for transmitting ions from an SRIG to a RF multipole ion guide with improved efficiency, reduced contamination of the final electrodes of the SRIG and reduced charging, fragmentation, and activation of the ions.

The longitudinal axis may be a central longitudinal axis and defines the path of ions through the interface ion guide. Centres of the apertures of the plate electrodes may be aligned along the longitudinal axis i.e. co-axial with the central longitudinal axis. The longitudinal axis is typically normal/orthogonal/perpendicular to the planar (major) surface(s) of each plate. A longitudinal distance or longitudinal direction referred to herein refers to a distance or direction parallel to the longitudinal axis.

Each plate electrode may comprise a plate, which is planar (i.e. substantially flat) and has two planar (major) surfaces. The plate of each plate electrode are arranged substantially parallel to each other. Each planar surface of each plate opposes and is spaced apart from the proximal planar surface of the adjacent plate along the longitudinal axis.

The plate of each plate electrode may have a thickness of 0.1-1.5 mm, preferably 0.1-0.9 mm, most preferably 0.3-0.7 mm and the spacing between the plates of adjacent plate electrodes may be 0.1-1.5 mm, preferably 0.1-0.9 mm, most preferably 0.3-0.7 mm. The thickness of each plate may be approximately the same as the spacing between adjacent plates. Each plate within the interface ion guide may have the same thickness. This is advantageous as the manufacturing process may be simplified. The spacing between adjacent plates may be the same throughout the interface ion guide. This is advantageous with regard to the electrical supply, since the capacitance between each electrode plate will be almost identical. One or more of the plates of the plate electrodes may have one or more additional openings formed in the planar surface that provide a path for gas to flow therethrough. The one or more additional openings minimize electrical capacitance of the interface ion guide, lead to reduced weight of the interface ion guide and also improve pumping speed when differentially pumping the SRIG and the interface ion guide. The one or more additional openings do not impinge the vacuum between the interface ion guide and the upstream SRIG because the gas limiting aperture will be the aperture of the last plate electrode of the SRIG that optionally has a diameter that is similar to the diameter of the channel formed by the protrusions of the plate electrodes of the interface ion guide. The plates are preferably rectangular or square in shape but may have other shapes such as circular or oval. The plates of the plate electrodes within the interface ion guide may have the same shape and dimensions as each other.

Each set of plate electrodes comprises at least two plate electrodes. The ion transfer device may have a plurality of sets of plate electrodes where each set of plate electrodes may have the same or a different number of plate electrodes. For example, within the ion transfer device, one set of plate electrodes may have four plate electrodes and another set of plate electrodes may have two plate electrodes. The number of sets of plate electrodes may be at least one and is preferably at least two. In a most preferred arrangement, four sets of plate electrodes may be employed in the ion transfer device.

In use, pairs of adjacent plate electrodes within each set of plate electrodes may have RF voltages that are out of phase with each other applied thereto. In other words, the first plate electrode within each pair may have an RF voltage applied thereto that is out of phase with the RF voltage applied to a second plate electrode within the pair. By “adjacent” it is meant that the plate electrodes have no intervening electrodes therebetween i.e. directly adjacent. In some arrangements, digital waveforms may be applied to the pairs of adjacent plate electrodes.

The RF voltage applied to the first plate electrode of each pair may be at least 60 degrees, preferably at least 120 degrees out of phase with the RF voltage applied to a second plate electrode of the same pair.

The RF voltage applied to the first plate electrode of each pair may be approximately 120 degrees out of phase with the RF voltage applied to a second plate electrode of the same pair.

The RF voltage applied to the first plate electrode of each pair may be approximately 180 degrees out of phase with the RF voltage applied to a second plate electrode of the same pair. In other words, for each pair of adjacent plate electrodes, an RF voltage may be applied to the first plate electrode within the pair of plate electrodes and an RF voltage of the opposite polarity may be applied to the second plate electrode within the pair of plate electrodes.

The plate of each plate electrode has an aperture formed therein, specifically formed in/through the planar (major) surface of the plate. The apertures are through-holes and extend through the thickness of the plate electrode and along the longitudinal axis. The plate electrodes are configured such that the apertures together define a continuous ion flight path through the set of plate electrodes along the longitudinal axis. The apertures may be formed of any shape, such as circular, oval, square, rectangular. The centre of each aperture is aligned with the longitudinal axis. The diameter of the aperture may be the same for each plate electrode. The diameter of each aperture may be approximately 2-30 mm.

In an arrangement where multiple sets of plate electrodes are employed, each set of plate electrodes are spaced apart from each other along the longitudinal axis, wherein the 1^{st} set of plate electrodes are upstream of the nth set of plate electrodes. Preferably the 1^{st} set of plate electrodes defines an ion inlet of the interface ion guide and the nth set of plate electrodes defines an ion outlet of the interface ion guide. The ion inlet may be defined by the apertures and protrusions of the first set of plate electrodes and the ion outlet may be defined by the apertures and protrusions of the nth set of plate electrodes. Preferably, the interface ion guide employs at least three sets of plate electrodes (i.e. n≥3).

Where multiple sets of plate electrodes are employed, in use, pairs of adjacent plate electrodes within each set of plate electrodes and pairs of adjacent plate electrodes across sets of plate electrodes have RF voltages applied thereto where the first plate electrode within each pair may have an RF voltage applied thereto that is out of phase with the RF voltage applied to a second plate electrode within the pair. For example, the most upstream plate electrode of a set of plate electrodes would have an RF voltage applied thereto that is out of phase with the most downstream plate electrode of the adjacent upstream set of plate electrodes. Therefore, when multiple sets of plate electrodes are assembled together, throughout the interface ion guide, adjacent plate electrodes would have RF voltages that are out of phase with each other applied thereto.

By “adjacent” it is meant that the plate electrodes have no intervening electrodes therebetween i.e. directly adjacent.

The RF voltage applied to the first plate electrode within each pair may be at least 60 degrees, preferably at least 120 degrees out of phase with the RF voltage applied to the second plate electrode within the same pair.

In one arrangement, the RF voltage applied to the first plate electrode within each pair is of opposite polarity (i.e. 180 degrees out of phase) with the RF voltage applied to the second plate electrode within the same pair. For example, the most upstream plate electrode of a set of plate electrodes would have an RF voltage applied thereto that is of opposite polarity to the most downstream plate electrode of the adjacent upstream set of plate electrodes. Therefore, when multiple sets of plate electrodes are assembled together, throughout the interface ion guide, adjacent plate electrodes would have RF voltages that are of opposite polarities applied thereto.

The spacing between each set of plate electrodes may be approximately the same as the spacing between the plates of adjacent plate electrodes within each set of plate electrodes.

Each plate electrode comprises one or more protrusions. The protrusions are part of the respective plate electrode such that applying a voltage, for example an RF voltage, to the plate electrode results the voltage being applied to/received by the protrusions of the respective plate electrode. In other words, a voltage applied to any part of the plate electrode is conducted to the protrusions of the plate electrode. In one example, the RF voltages may be applied to the plate of a plate electrode and conducted to the protrusions of that plate electrode. For each plate electrode, the one or more protrusion(s) may be electrically connected/electrically coupled to the respective plate of the plate electrode.

Preferably, each plate electrode comprises two or more protrusions. Each protrusion extends at a non-zero angle to the planar surface of the respective plate. For each plate electrode, the non-zero angle between the planar surface and each protrusion may be the same or may be different. For example, a plate electrode may comprise first and second protrusions where the first protrusion extends at a first non-zero angle to the planar surface and the second protrusion extends at a second non-zero angle to the planar surface where the first and second non-zero angles are different. The (or each) non-zero angle may be approximately 80-100°, preferably approximately 85-95°, more preferably approximately 89-91°, most preferably approximately 90°. The protrusions may extend transverse to the planar surface(s) of the respective plate. The non-zero angle may be specifically between the inner surface of the protrusion and the longitudinal axis. The protrusions extending at approximately 90° to the planar surface of the plate (i.e. parallel to the longitudinal axis) enables the protrusions to generate an RF field of a certain order to guide ions along the longitudinal axis through the ion guide.

The protrusions and apertures of each set of plate electrodes may define a channel for the transmission of ions therethrough that is co-axial with the longitudinal axis. The channel formed by the protrusions does not have a complete contour as the protrusions of each set of plate electrodes are spaced apart from each other about the longitudinal axis. In other words, when assembled together to form a set of plate electrodes, each protrusion is spaced apart from an adjacent protrusion (i.e. the proximal/closest protrusion) such that the protrusions are circumferentially/concentrically arranged around the longitudinal axis.

Adjacent protrusions within a set of plate electrodes may form pairs of adjacent protrusions. The term “adjacent” means no intervening protrusions i.e. directly adjacent. Each pair of adjacent protrusions may have a first protrusion and a second protrusion where the first protrusion is part of a plate electrode configured to have a first RF voltage applied thereto and a second protrusion that is part of a plate electrode configured to have a second RF voltage applied thereto where the first RF voltage is out of phase with the second RF voltage. The first RF voltage may be at least 60 degrees, preferably at least 120 degrees out of phase with the second RF voltage. In one arrangement, the first RF voltage is of opposite polarity (i.e. 180 degrees out of phase) to the second RF voltage such that, in use, adjacent protrusions have RF voltages of opposite polarities applied thereto.

One or more of the protrusion(s) may longitudinally extend at the non-zero angle to the planar surface through the aperture of at least two, preferably all, of the plate electrodes within the respective set of plate electrodes. One or more of the protrusion(s) may extend from a first planar surface of the respective plate and/or one or more of the protrusions may extend from a second planar surface of the respective plate.

One or more of the protrusion(s) may extend from the periphery of the aperture of the respective plate radially inward (i.e. towards the longitudinal axis) and also longitudinally at the non-zero angle to the planar surface (preferably parallel to the longitudinal axis). One or more of the protrusion(s) may longitudinally extend through the aperture of at least two, preferably all, of the plate electrodes within the respective set of plate electrodes. One or more of the protrusion(s) may extend longitudinally between a first end and a second end. The protrusions may be configured such that, when the plate electrodes are assembled as a set of plate electrodes, the first ends are aligned with each other and the second ends are aligned with each other. One or more of the protrusion(s) may extend longitudinally towards an ion inlet of the interface ion guide and/or longitudinally towards an ion outlet of the interface ion guide. For each set of plate electrodes, the protrusions of the plate electrode proximal to ion inlet (i.e. the upstream plate electrode of the respective set of plate electrodes) may extend longitudinally from the periphery of the aperture towards the ion outlet. For each set of plate electrodes, the protrusions of the plate electrode proximal to the ion outlet (i.e. the downstream plate electrode of the respective set of plate electrodes) may extend longitudinally from the periphery of the aperture towards the ion inlet. For each set of plate electrodes, the protrusions of the intermediatory plate electrodes (i.e. between the upstream plate electrode and the downstream plate electrode within the respective set of plate electrodes) may extend from the periphery of the aperture both longitudinally towards the ion inlet and towards the ion outlet such that an intermediate point between the first end and the second end of the protrusion contacts the periphery of the respective aperture.

Each protrusion may have an inner surface that is radially inward of the periphery of the aperture. The inner surface may have a length extending at the non-zero angle to the planar surface and a width extending perpendicular to the length. The non-zero angle between the protrusion and the planar surface referred to above may refer specifically to the angle between the length (longitudinal dimension) of the inner surface of the protrusion and the planar surface. The length of the inner surface preferably extends parallel to the longitudinal axis such that the non-zero angle to the planar surface is approximately 90 degrees. The inner surface may be planar. The width may extend from a first edge to a second edge of the inner surface. The width may define the angular extent of the protrusion, which may be considered as being the angle about the longitudinal axis between the first edge and the second edge. More specifically, the angular extent may be the angle about the longitudinal axis between a radius from the longitudinal axis to the first edge and a radius from the longitudinal axis to the second edge.

One of more of the protrusion(s) may also have an outer surface that is proximal to the periphery of the respective aperture and has a length extending at an angle referred to herein as a second non-zero angle, to the planar surface of the respective plate, which may be different from the non-zero angle between the planar surface and the inner surface of the protrusion. The second non-zero angle between the outer surface and the planar surface may be approximately 20-100°, preferably approximately 30-50°.

For one or more of the protrusion(s), the width of the inner surface may be smaller than the width of the outer surface. Accordingly, one or more protrusion(s) may be tapered along the radial direction and so formed as a wedge shape.

The protrusions may be formed as a curved sheet that extends radially inward from the inner periphery of the aperture and bends through the non-zero angle. The non-zero angle may be between 80 and 100°, preferably between 85 and 95°. In such an arrangement, the second non-zero angle, which is between the outer surface of the protrusion and the planar surface of the plate, is the same as the non-zero angle, which is between the inner surface of the protrusion and the planar surface of the plate.

One or more of the protrusion(s) may be configured such that the distance from the protrusion (particularly the inner surface of the protrusion) to the longitudinal axis (i.e. along the radial direction) is constant between its first end and its second end. A distance along the radial direction may be referred to herein as the radial distance. One or more of the protrusion(s) may be configured such that the radial distance between the protrusion (particularly the outer surface of the protrusion) and the periphery of the apertures of the plate electrodes increases with distance from the periphery of the respective aperture. One or more of the protrusion(s) may be tapered from their first end to their second end such that the radial distance between the protrusion (particular the outer surface of the protrusion) and the periphery of the apertures of the plate electrodes within the respective set of plate electrodes increases from its first end proximal to the periphery of the respective aperture to its second end distal from the respective aperture. This achieves reduced capacitance and enables easier assembly and decreased weight. This also enables better pumping of the interface ion guide to achieve the pressure desired.

In one arrangement, for one or more of the protrusion(s), the radial distance between the protrusion and the longitudinal axis may be constant along the length of the protrusion while increasing the radial distance between the protrusion and the periphery of the respective apertures of the plate electrodes with distance from the periphery of the respective aperture.

The protrusions may be integrally formed with the plate of the plate electrode. The plate electrode, which includes the respective protrusions and plate, may be of unitary construction. In other words, each protrusion may be of unitary construction with the respective plate electrode. In one example, in an arrangement where the protrusions are formed as a curved sheet, the protrusions may be extensions of the plate extending from the periphery of the respective aperture that have been bent out of the plane of the planar surface of the plate.

Alternatively, the protrusions may be separately formed from the plate and secured to the plate of the plate electrode, preferably secured to the periphery of the aperture formed in the plate. The protrusions may be secured to the plate by, for example, welding or soldering.

The plate electrode, including the protrusions, are formed of an electrically conductive material.

The protrusions of each set of plate electrodes are configured to generate an RF multipole field to focus ions towards the longitudinal axis and guide ions through the apertures of the plate electrodes. RF multipole fields are known in the art as being generated using rods concentrically arranged around an axis. Accordingly, in the claimed invention, the protrusions of each set of plate electrodes extending at a non-zero angle to the planar surface of the plate are configured to generate an RF multipole field. The protrusions of each set of plate electrodes may be configured to generate an RF multipole field of the Nth order. N may be ≥2. The RF multipole field of the Nth order may be regular or irregular. An RF multipole field of the 2^{nd} order refers to a quadrupole RF field. The RF multipole field of the 3^{rd} order refers to a hexapole RF field. The RF multipole field of the 4^{th} order refers to a octapole RF field. The RF multipole field of the 5^{th} order refers to a decapole RF field. The RF multipole field of the 6^{th} order refers to a dodecapole RF field.

For generation of a regular RF multipole field, the number of protrusions in the set of plate electrodes corresponds to the order of the field and each of the protrusions contributes equally to the RF field.

For example, where the order of the field is six, twelve protrusions are employed in the set of plate electrodes that equally contribute to the RF field. The twelve protrusions may be part of any of the plate electrodes within the set of plate electrodes, providing that adjacent protrusions are part of plate electrodes having RF voltages of opposite polarities applied thereto as discussed above. Optionally, the twelve protrusions may be equally distributed between the set of plate electrodes. The twelve protrusions may be equally spaced about the longitudinal axis (i.e. 30 degrees from each other) and may have the same radial distance to the longitudinal axis (specifically the same radial distance from their inner surface to the longitudinal axis) and their inner surfaces may have the same width. Such a dodecapole RF field would be approximately the same as a dodecapole RF multipole field of the same order generated using rod electrodes. For generation of a regular RF multipole field of the second order (i.e. a quadrupole RF field), four protrusions may be employed in the set of plate electrodes that equally contribute to the RF field. The four protrusions may be equally spaced about the longitudinal axis (i.e. 90 degrees from each other) and may have the same radial distance to the longitudinal axis (specifically the same radial distance from their inner surface to the longitudinal axis) and their inner surfaces may have the same width. The four protrusions may be part of any of the plate electrodes within the set of plate electrodes providing that adjacent protrusions are part of plate electrodes having RF voltages of opposite polarities applied thereto as discussed above. Optionally, the four protrusions may be equally distributed between the set of plate electrodes. Such a quadrupole RF field would be approximately the same as the quadrupole RF multipole field generated using rods. For generation of an irregular RF multipole field, the protrusions in the set of plate electrodes may not equally contribute to the RF field as discussed in further detail below.

The protrusions of the first set of plate electrodes may be configured to generate an RF multipole field of higher order than the protrusions of the nth set of plate electrodes. The higher acceptance area of the higher order RF multipole field is advantageous for receiving ions at atmospheric pressure and the increased radial confinement of the downstream, lower RF multipole field is advantageous for efficient transmission to the downstream RF multipole ion guide.

Within a set of plate electrodes, the protrusions of a single plate electrode may extend for the same length in the longitudinal direction i.e. in the direction of the ion transmission through the interface ion guide. This results in a simplified design of each individual plate electrode and resulting reduction in cost.

In a preferred arrangement, the protrusions of the first set of plate electrodes are configured to generate a RF multipole field of the 6^{th} order and/or the protrusions of the nth set of plate electrodes are configured to generate an RF multipole field of the 2^{nd} order as discussed above. It is advantageous for the protrusions of the first set of plate electrodes (i.e. the most upstream set of plate electrodes that may define the ion inlet of the interface ion guide) to generate an RF field of the 6^{th} order as this is similar to the RF field generated by the SRIG and has a similar acceptance area thereby smoothing the transition from the SRIG. It is advantageous for the final (nth) set of plate electrodes (i.e. the most downstream set of plate electrodes that may define the ion outlet of the interface ion guide) to generate an RF field of the 2^{nd} order, since this would have substantially the same acceptance area as a downstream quadrupole ion guide thereby smoothing the transition to the downstream RF multipole ion guide. The intermediate sets of plate electrodes (i.e. those between the 1^{st} and nth set of plate electrodes) may generate irregular RF multipole fields, such as irregular dodecapole RF fields. The intermediate sets of plate electrodes from the 1^{st} and nth set of plate electrodes may generate irregular dodecapole RF fields with decreasing acceptance areas. In other words, each intermediate set of plate electrodes may generate an irregular dodecapole RF field of lower acceptance area than the adjacent upstream intermediate set of plate electrodes such that the acceptance area of the RF field generated is gradually reduced from the regular dodecapole RF field generated by the first set of plate electrodes to the regular quadrupole RF field generated by the nth set of plate electrodes. The decreasing acceptance area concentrates ions towards the centre of the longitudinal axis, which is advantageous because the electrical field in the centre is low compared to the area close to the plate electrodes thereby avoiding collisional activation and/or heating that can lead to unintended loss of ions. The intermediate sets of plate electrodes may each employ twelve protrusions but each of the twelve protrusions do not equally contribute to the RF field in contrast to the protrusions of the first set of plate electrodes, as discussed in further detail below.

In known arrangements, the order of the RF multipole field generated depends on the number of rods employed. In the claimed invention, the order of the RF multipole field generated by each set of plate electrodes depends on the number of protrusions within the set of plate electrodes. For regular RF multipole fields the protrusions equally contribute to the RF multipole field generated and so have the same radial distance to the longitudinal axis (specifically the same radial distance between the inner surface of the protrusion and the longitudinal axis) and their inner surfaces may have the same width (such that the protrusions are of the same angular extent).

The acceptance area of an irregular RF multipole field may be varied by varying the radial distance to the longitudinal axis (specifically the radial distance from the inner surface to the longitudinal axis) for certain protrusions and the width of the inner surface of the protrusion (i.e. the angular extent) of certain protrusions within the set of plate electrodes. By way of example, each set of electrodes between the first set and the nth set of plate electrodes (the intermediatory set of plate electrodes) may have the same number of protrusions as the first set of electrodes, which may be twelve protrusions. Four of the twelve protrusions are referred to herein as primary protrusions and are spaced 90 degrees apart from each other about the longitudinal axis and would generate a quadrupole RF field if provided in isolation of the remaining eight protrusions referred to herein as the secondary protrusions. The primary protrusions may be aligned with the protrusions of the nth set of plate electrodes about the longitudinal axis. For each intermediatory set of electrodes, in the direction from upstream to downstream (i.e. from the 2^{nd} set of plate electrodes to the (n−1)th set of plate electrodes), the primary protrusions may be configured to have a more dominant/greater effect on the RF multipole field generated compared to the secondary protrusions thereby reducing the acceptance area of the RF multipole field generated. The primary protrusions may be configured to have a greater effect on the RF multipole field generated than the secondary protrusions by increasing the width of the inner surfaces of the primary protrusions (i.e. widening the angular extent) and/or reducing the radial distance between the inner surfaces of the primary protrusions and the longitudinal axis and/or increasing the radial distance from the inner surfaces of the secondary protrusions to the longitudinal axis. It is preferable to increase the effect of the primary protrusion compared to the secondary protrusions on the RF multipole field generated by increasing the radial distance from the inner surfaces of the secondary protrusions to the longitudinal axis rather than decreasing the radial distance from the inner surfaces of the primary protrusions to the longitudinal axis. This is because decreasing the radial distance from the inner surfaces of the primary protrusion to the longitudinal axis would require increased background gas pressure or an adjustment of the amplitude of the RF voltage applied.

In an alternative arrangement, the protrusions of each set of plate electrodes between the first set of plate electrodes and the nth set of electrodes (the intermediate sets of plate electrodes) may be configured such that the order of the RF multipole field generated decreases sequentially for each set of plate electrodes from the first set of plate electrode to the nth set of plate electrodes. For example, the number of protrusions in each set of plate electrodes may decrease from the first set of plate electrodes to the nth set of plate electrodes. The protrusions may be configured to generate regular RF multipole fields. In an exemplary embodiment, the protrusions of the first set of plate electrodes may be configured to generate a regular RF multipole field of the 6^{th} order. The protrusions of the 2^{nd} and 3^{rd} set of plate electrodes sequentially decrease the order the RF multipole field and the protrusions of the 4^{th} set of plate electrodes may be configured to generate a regular RF multipole field of the of the 4^{th} order. In an alternative exemplary embodiment, the protrusions of the first set of plate electrodes may be configured to generate a regular RF multipole field of the 6^{th} order. The protrusions of the 2^{nd} and 3^{rd} set of plate electrodes sequentially decrease the order the RF multipole field and the protrusions of the 4^{th} set of plate electrodes may be configured to generate a regular RF multipole field of the of the 3^{rd} order. In an alternative exemplary embodiment, the protrusions of the first set of plate electrodes may be configured to generate a regular RF multipole field of the 6^{th} order, the protrusions of the 2^{nd} set of plate electrodes may be configured to generate a regular RF multipole field of the 3^{rd} order and the protrusions of the 3^{rd} set of plate electrodes may be configured to generate a regular RF multipole field of the of the 2^{nd} order.

By providing a set of plate electrodes generating an RF-multipole field where the plate electrodes are spaced apart from each other in the longitudinal direction, the electrical connection to the ion guide assembly is simplified. The voltage supply for the individual plate electrodes of a set of plate electrodes may be connected in a similar manner as the voltage supply for the electrodes of an upstream SRIG. For example, as discussed above, an RF multipole field of the 6^{th} order can be generated using four plate electrodes and so only four electrical connections may be needed.

The interface ion guide may comprise a housing encasing the plate electrodes. The housing may comprise an entrance aperture and an exit aperture. The entrance and exit apertures may be aligned with the apertures of the plate electrodes and so centred with the longitudinal axis. The housing may be a vacuum chamber. The housing may also encase the SRIG as discussed in further detail below.

As discussed above, in use, pairs of adjacent plate electrodes within each set of plate electrodes may have RF voltages that are out of phase with each other, particularly 180 degrees out of phase (i.e. of opposite polarities) applied thereto. In other words, for each pair of adjacent plate electrodes, an RF voltage may be applied to the first plate electrode within the pair of plate electrodes and an RF voltage that is out of phase with the voltage applied to the first plate electrode (for example, 120 or 180 degrees out of phase) may be applied to the second plate electrode within the pair of plate electrodes. Where multiple sets of plate electrodes are employed, in use, pairs of adjacent plate electrodes within each set of plate electrodes and pairs of adjacent plate electrodes across sets of plate electrodes have RF voltages that are out of phase with each other (for example, RF voltages of opposite polarities) applied thereto. Therefore, when multiple sets of plate electrodes are assembled together, throughout the interface ion guide, adjacent plate electrodes would have RF voltages that are out of phase, for examples RF voltages of opposite polarities, applied thereto.

As discussed above, adjacent protrusions within a set of plate electrodes may form pairs of adjacent protrusions. Each pair of adjacent protrusions may have a first protrusion that is part of a plate electrode configured to have an RF voltage applied thereto and a second protrusion that is part of a plate electrode configured to have an RF voltage that is out of phase with the RF voltage applied to the first protrusion applied thereto. Consequently, in use, adjacent protrusions have voltages that are out of phase with each other, particularly voltages of opposite polarities, applied thereto.

Ions enter the interface ion guide via an entrance aperture in the housing and the ion inlet formed by the apertures and protrusions of the first set of plate electrodes. Ions travel through the channel defined by the protrusions and the apertures of the subsequent plate electrodes along the longitudinal axis. The RF multipole field generated by the protrusions of the plate electrodes focusses the ions towards the longitudinal axis. When the ions are close to the longitudinal axis, the RF voltages cancel out resulting in little to no radial force being exerted on the ions but as ions move away from the longitudinal axis (i.e. towards the protrusions), the RF field from the protrusions pushes the ion radially inward towards the longitudinal axis.

If the gas velocity across the sets of plate electrodes is not high enough to move ions through the interface ion guide, then a DC field gradient may be applied across the interface ion guide. The DC field gradient may be applied across the plate electrodes, for example, by applying a DC voltage to one or more of the plate electrodes. The DC field accelerates ions towards the nth set of plate electrodes. The DC voltages applied to the one or more plate electrodes can be adjusted to enhance the ion beam transfer and ion confinement. The same DC voltage may be applied to plate electrodes within a set of plate electrodes. However, each set of plate electrodes may have a different DC voltage applied thereto to compared to other sets of plate electrodes to generate the DC field gradient. In an arrangement, additional DC plate electrodes without protrusions may be arranged between adjacent sets of plate electrodes. The additional DC plate electrodes may have DC voltages applied thereto to generate the DC field gradient across the interface ion guide. The apertures of the DC plate electrodes would be aligned with the apertures of the sets of plate electrodes.

Ions leave the interface ion guide via the ion outlet defined by the protrusions and apertures of the nth set of plate electrodes and the exit aperture formed in the housing. As discussed above, on increasing distance along the longitudinal direction from the first set of plate electrodes (i.e. from upstream to downstream), the RF multipole field generated has a reduced acceptance area and increases confinement of ions towards the longitudinal axis. This therefore smooths the transition from the SRIG, which has a wide acceptance area to a downstream multipole ion guide employing rods and having a low acceptance area, particularly a downstream quadrupole ion guide.

The claimed invention also relates to an ion transfer assembly configured to receive ions from an ion source and transfer ions to a downstream RF multipole ion guide and/or mass analyser, the ion transfer assembly having a longitudinal axis and comprising a stacked ring ion guide (SRIG) configured to receive ions from the ion source and the interface ion guide of any of the embodiments described above, which is coupled to and downstream from the SRIG.

The SRIG may comprise two or more SRIG plate electrodes, each SRIG plate electrode comprising a plate comprising a planar surface and an aperture formed in the planar surface for transmission of ions therethrough along the longitudinal axis. The plates of the SRIG plate electrodes are spaced apart from each other along a longitudinal axis of the SRIG. The longitudinal axis of the SRIG and the longitudinal axis of the interface ion guide may be aligned with the longitudinal axis of the ion transfer assembly. The longitudinal axis of the interface ion guide may be co-axial with the longitudinal axis of the ion transfer assembly. The planar surfaces of the plates of the SRIG are preferably substantially parallel to each other and perpendicular to the longitudinal axis.

The description above in respect of the interface ion guide equally applies to the ion transfer assembly employing the interface ion guide together with a SRIG.

The spacing between each plate of the interface ion guide along the longitudinal axis of the interface ion guide may be approximately the same as the spacing between each plate of the SRIG along the longitudinal axis of the SRIG. Additionally or alternatively, the thickness of each plate of the interface ion guide may be approximately the same as the thickness of each plate of the SRIG. The thickness of each plate of the SRIG may be 0.1 mm to 0.9 mm and the spacing between each plate of the SRIG may be between 0.1 mm and 0.9 mm. Advantageously, the spacing of the plates of the interface ion guide may be the approximately the same as the spacing of at least some of the plate of the SRIG, particularly the downstream plates of the SRIG. If the spacing between the plates of the SRIG is irregular, such as in U.S. Pat. No. 7,781,828, then the spacing between the plates of the interface ion guide may be approximately the same as the spacing of the most downstream plates of the SRIG.

Similarly, the thickness of the plates of the interface ion guide may be the approximately the same as the thickness of the plates of the SRIG. Maintaining the spacing and/or thickness of the plates of the interface ion guide to be the same as the spacing and/or thickness of the SRIG is advantageous, since RF voltages of the same amplitude and/or frequency can be applied to the SRIG plate electrodes and the interface ion guide plate electrodes thereby reducing fringing fields between the SRIG and interface ion guide and avoiding the need for a DC electrode therebetween. The absence of the DC electrode and the reduced fringing fields reduces charging and contamination of the final electrodes of the SRIG and also reduces fragmentation and activation of the ions. It is possible for the thickness and/or spacing to be the same, since the order and/or acceptance area of the RF multipole field generated by the interface ion guide is achieved by the configuration of the protrusions rather than the spacing or thickness of the plates. The protrusions within the interface ion guide extend radially inward of the respective aperture and then through the apertures of the plates within the set of plate electrodes. As the protrusions extend through the apertures of the plates within the set of plate electrodes, the longitudinal dimension of the protrusions does not impact the spacing between the plates. In use, with an RF voltage applied thereto, the field generated and so the movement of ions through the interface ion guide is controlled by the positioning and configuration of the protrusions.

The SRIG contains one or more SRIG plate electrodes that may be similarly configured to the plate electrodes of the interface ion guide except that the SRIG plate electrodes do not contain any protrusions. The SRIG plate electrodes are configured such that the apertures of the SRIG plate electrodes and the apertures of the interface ion guide together define a continuous ion flight path. The apertures of the SRIG plate electrodes are through-holes formed in the plates of the SRIG plate electrodes. In particular, the apertures of the SRIG plate electrodes are formed in the planar surface(s) of the respective SRIG plates such that the apertures extend through the thickness of the plate i.e. along the longitudinal axis. The apertures may be formed of any shape, such as circular, oval, square, rectangular. The centre of each aperture is aligned along the longitudinal axis of the SRIG, which is co-axial with/aligned with the longitudinal axis of the interface ion guide. The apertures of the SRIG plate electrodes may have the same diameter as each other. Alternatively, the SRIG may be comprise or be an ion funnel where the apertures of the SRIG plate electrodes decrease in diameter along the longitudinal direction. The apertures of the SRIG plate electrodes may of the same shape as the apertures of the plate electrodes of the interface ion guide. The apertures of the SRIG plate electrodes may be of the same diameter and/or shape as the channel formed by the protrusions of the plate electrodes of the interface ion guide. The plates of the SRIG plate electrodes may be of the same dimensions and formed of the same material as the plates of the interface ion guide. The plates are optionally rectangular but may be other shapes such as square, circular or oval. In one arrangement, the plates of the SRIG plate electrodes may be circular or oval (i.e. ring shaped) and the plates of the interface ion guide may be square or rectangular.

The interface ion guide is configured to receive ions from the SRIG. For example, the ion outlet of the SRIG may be coupled to an ion inlet of the interface ion guide.

The SRIG may be at a higher pressure than the interface ion guide. The SRIG may be at sub-atmospheric pressure, typically between 0.1-10 mbar. The interface ion guide may be at a pressure of less than 10 mbar, preferably less than 1 mbar, more preferably in the range between 0.1 mbar and 1.0 mbar. The pressure different may depend on the size of the aperture of the most downstream SRIG plate electrode and the length of the interface ion guide.

The SRIG plate electrodes may be housed/encased within a housing. As discussed above, the SRIG may be encased within the same as housing the interface ion guide, the housing having an entrance aperture and an exit aperture. In such an arrangement, the most downstream plate electrode of the SRIG is directly adjacent to the most upstream plate of the interface ion guide. The entrance aperture may be proximal to the most upstream SRIG plate electrode and the exit aperture may be proximal to the most downstream interface ion guide plate electrode. The entrance and exit apertures may be aligned with the apertures of the SRIG plate electrodes and interface ion guide plate electrodes and so centred with the longitudinal axis of the SRIG and interface ion guide. The SRIG and interface ion guide may be provided in different portions of the housing that are differentially pumped so that the portion of the housing containing the SRIG is at a higher pressure than the portion of the housing containing the interface ion guide. The different portions of the housing that are differentially pumped are referred to herein as differential pumping stages. The differential pumping stages may be separated from each other by, for example, the most downstream plate electrode of the SRIG and a seal.

As the SRIG and interface ion guide may be contained within the same housing and both contain plate electrodes spaced apart along the longitudinal axis, the SRIG and the interface ion guide may be mounted within the same holder of the housing. The holder may contain one or more PCB(s) and the SRIG and interface ion guide may be coupled to, for example mounted on, the same PCB. Therefore, the assembly may be simplified and cheaper. Within the housing, insulating material may be provided between the most downstream plate electrode of the SRIG and the most upstream plate electrode of the interface ion guide. Insulating material may be desirable to lower the gas load from the pumping stage of the SRIG to the pumping stage of the interface ion guide.

Alternatively, the SRIG and the interface ion guide may be housed within separate housings coupled together such that the SRIG is directly upstream of the interface ion guide.

A capillary may extend though the entrance aperture, such that ions may be introduced from the ion source into the SRIG housing via the capillary. Alternatively, the entrance aperture and/or the capillary may be misaligned (i.e. not coaxial) with the apertures of the SRIG plate electrodes, and so off-centre from the longitudinal axis of the SRIG. In addition, the capillary may be at an angle to the longitudinal axis of the SRIG.

The ion transfer assembly may further comprise a downstream RF multipole ion guide and/or mass analyser that is downstream of the interface ion guide. The downstream RF multipole ion guide may be a quadrupole ion guide employing longitudinally extending rods spaced apart about a longitudinal axis to generate a quadrupole RF multipole field as would be known in the art. The downstream RF multipole ion guide is configured to receive ions from the interface ion guide. For example, the ion outlet of the interface ion guide may be coupled to an ion inlet of the downstream RF multipole ion guide. The longitudinal axis of the downstream RF multipole ion guide is aligned with (co-axial with) the longitudinal axis of the ion transfer assembly.

The downstream RF multipole ion guide may be housed within a housing encasing the longitudinally extending rods. The housing is optionally the same housing as that encasing the SRIG and the interface ion guide. The SRIG, the interface ion guide and the downstream RF multipole ion guide may each be arranged within differential pumping stages within the housing. The pumping stage containing the interface ion guide may be at a pressure between the pressure of the pumping stage containing the SRIG and the pressure of the pumping stage containing the downstream RF multipole ion guide. The differential pumping stage of the downstream RF multipole ion guide may be separated from the interface ion guide by, for example, the most downstream plate electrode of the interface ion guide and a seal. As discussed above, the housing comprises an entrance aperture and an exit aperture. The entrance and exit apertures may be centred with the longitudinal axis of the downstream RF multipole ion guide, which is in turn optionally centred with the longitudinal axis of the SRIG and interface ion guide.

Alternatively, the housing may only house the SRIG and/or the interface ion guide. The downstream RF multipole ion guide may have a separate housing that is a vacuum chamber and configured to be coupled to the exit aperture of the housing of the interface ion guide, for example via a load-lock. The vacuum chamber formed by the housing of the interface ion guide may be configured to be at a pressure between the pressure of the vacuum chamber formed by the housing of the SRIG and a pressure of the vacuum chamber formed by the housing of the downstream RF multipole ion guide.

In an embodiment, there may be a SRIG having a housing that is a vacuum chamber and a multipole RF ion guide having a separate housing that is also a vacuum chamber where the SRIG and the multipole RF ion guide are coupled together via a load-lock. The interface ion guide described above may form an integral part of the load-lock. When the load-lock is closed, the vacuum chamber housing the SRIG is isolated from the vacuum chamber housing the multipole RF ion guide by the load-lock. Ion transmission between the SRIG and the multipole RF ion guide is interrupted. When the load-lock is opened, the sets of electrodes of the interface ion guide within the load-lock may be positioned between the SRIG and the multipole RF ion guide. In such an arrangement, the load-lock aperture may contain the set(s) of electrodes of the interface ion guide.

In an embodiment of the interface ion guide, some of the set(s) of plate electrodes may be contained within a load-lock. The load-lock may be arranged between a first part of the interface ion guide having one or more of the set(s) of the plate electrodes described above and a second part of the interface ion guide having one or more of the set(s) of plate electrodes described above. When the load-lock is closed, the first part of the interface ion guide is isolated from the second part of the interface ion guide by the load-lock. Ion transmission through the interface ion guide is interrupted. When the load-lock is opened, the set(s) of electrodes within the load-lock may be positioned between the first part and the second part of the interface ion guide. In such an arrangement, the load-lock aperture contains one or more of the set(s) of electrodes of the interface ion guide.

The claimed invention also relates to a method of transmitting ions from a stacked ring ion guide (SRIG) to a multipole ion guide using the interface ion guide described above, the method comprising applying RF voltages that are out of phase with each other, optionally RF voltages of opposite polarities (i.e. 180 degrees out of phase with each other), to pairs of adjacent plate electrodes within each set of plate electrodes of the interface ion guide to generate an RF multipole field for each set of plate electrodes that focuses ions towards the longitudinal axis. The method may optionally further comprise applying a DC voltage to one or more of the plate electrodes of the interface ion guide to generate a DC field that drives ions along the longitudinal axis. The same DC voltage may be applied to plate electrodes within a set of plate electrodes. However, each set of plate electrodes may have a different DC voltage applied thereto to generate the DC field gradient. In an arrangement, additional DC plate electrodes without protrusions may be arranged between adjacent sets of plate electrodes having RF voltages applied thereto. The additional DC plate electrodes may have DC voltages applied thereto to generate the DC field gradient. The apertures of the DC plate electrodes would be aligned with the apertures of the sets of plate electrodes. While a DC voltage is not required between the SRIG and the interface ion guide or to the most upstream plate electrode of the interface ion guide, as discussed above, it may still be advantageous to apply a DC voltage to one or more of the plate electrodes within the interface ion guide to generate a DC gradient across the longitudinal axis of the ion guide. This DC gradient drives ions through the interface ion guide.

The method may further comprise applying RF voltages of opposite polarities to pairs of adjacent SRIG plate electrodes to generate an RF field that focuses ions towards the longitudinal axis of the SRIG. The RF voltages of opposite polarities applied to the pairs of adjacent plate electrodes of the interface ion guide are at the same frequency and/or amplitude as the RF voltages applied to the pairs of adjacent SRIG plate electrodes. As discussed above, preferably, the spacing between each plate of the interface ion guide along the longitudinal axis of the interface ion guide is approximately the same as the spacing between the downstream plates of the SRIG along the longitudinal axis of the SRIG, and/or the thickness of each plate of the interface ion guide is approximately the same as the thickness of each plate of the SRIG. A DC voltage may be applied to one or more of the plate electrodes within the SRIG to generate a DC gradient across the longitudinal axis of the SRIG. This DC gradient drives ions through the SRIG.

### BRIEF DESCRIPTION OF DRAWINGS

FIG. 1 is a schematic diagram of a perspective view of an interface ion guide according to an exemplary embodiment present invention.

FIG. 2 is a schematic diagram of a longitudinal section of the interface ion guide of FIG. 1, which employs first, second, third and fourth sets of plate electrodes.

FIG. 3 is a schematic diagram of an exploded view of the first set of plate electrodes of the interface ion guide of FIG. 1.

FIGS. 4(a)-4(d) are schematic diagrams of sectional views each of the first, second, third and fourth sets of plate electrodes of the interface ion guide, respectively, of FIG. 1.

FIG. 5(a) is a schematic diagram of a perspective view of a section of an ion transfer assembly according to an exemplary embodiment of the claimed invention, the ion transfer assembly comprising the interface ion guide of FIG. 1, a SRIG and a downstream RF multipole ion guide where the SRIG is upstream of the interface ion guide, which is upstream of the downstream RF multipole ion guide.

FIG. 5(b) is a schematic diagram of a sectional view of the section of the ion transfer assembly shown in FIG. 5(a).

FIG. 6(a) is a contour plot of equipotential line showing the RF field generated by the ion transfer assembly of FIG. 5. The potential energy diagram is in respect of a plan view of a longitudinal section of the assembly. The equipotential line was calculated using simulations.

FIG. 6(b) illustrates the calculated potential energy surface of the RF field of FIG. 6(a).

FIG. 7(a) is a part of the contour plot of FIG. 6(a).

FIG. 7(b) is a potential energy diagram showing the RF field generated by a set of SRIG plate electrodes. The potential energy diagram is in respect of a cross-section along the electrode labelled with reference numeral 61i in FIG. 7(a). The potential energy diagram was calculated using simulations.

FIG. 7(c) is a potential energy diagram showing the RF field generated by the first set of plate electrodes of the interface ion guide. The potential energy diagram is in respect of a cross-section along the electrode labelled with reference numerals 100b′ in FIG. 7(a). The potential energy diagram was calculated using simulations.

FIG. 7(d) is a potential energy diagram showing the RF field generated by the second set of plate electrodes of the interface ion guide. The potential energy diagram is in respect of a cross-section along the electrode labelled with reference numeral 100b″ in FIG. 7(a). The potential energy diagram was calculated using simulations.

FIG. 7(e) is a potential energy diagram showing the RF field generated by the third set of plate electrodes of the interface ion guide. The potential energy diagram is in respect of a cross-section along the electrode labelled with reference numeral 100b′″ in FIG. 7(a). The potential energy diagram was calculated using simulations.

FIG. 7(f) is a potential energy diagram showing the RF field generated by the fourth set of plate electrodes of the interface ion guide. The potential energy diagram is in respect of a cross-section along the electrode labelled with reference numeral 100a″″ in FIG. 7(a). The potential energy diagram was calculated using simulations.

FIG. 7(g) is a potential energy diagram showing the RF field generated by the downstream RF multipole ion guide of the ion transfer assembly.

FIGS. 8(a)-8(d) are schematic diagrams of an alternative configuration of a plate electrode according to an exemplary embodiment of the claimed invention that may optionally be employed in the ion transfer device of FIG. 1 and the ion transfer assembly of FIG. 5. FIG. 8(a) is a perspective view, FIG. 8(b) is a side-on view. FIG. 8(c) is a plan view from above and FIG. 8(d) is a second side-on view.

FIG. 9(a)-9(b) are schematic diagrams of perspective views of a set of plate electrodes employing the plate electrodes of FIG. 8 that may optionally be employed in the ion transfer device of FIG. 1 and the ion transfer assembly of FIG. 5. FIG. 9(a) is a sectional view of FIG. 9(b).

### DETAILED DESCRIPTION

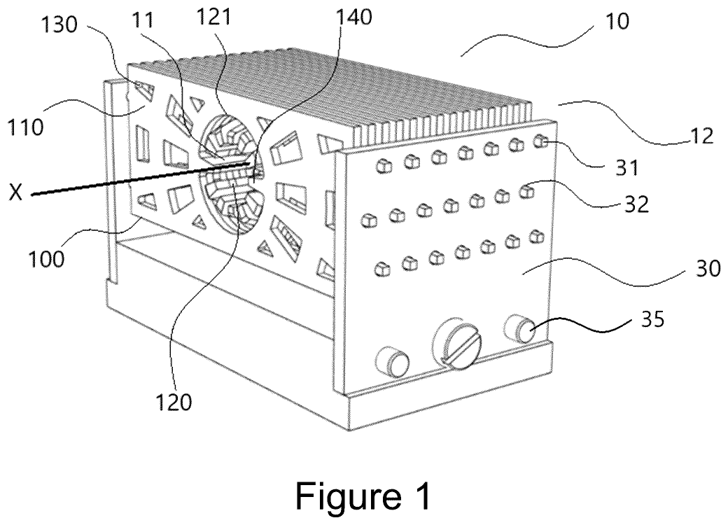

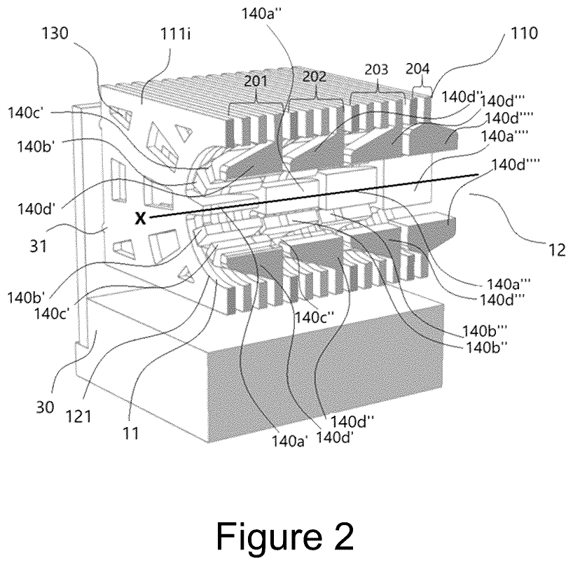

FIG. 1 shows an exemplary embodiment of an interface ion guide 10 according to the claimed invention and FIG. 2 shows a longitudinal section of the interface ion guide 10. The interface ion guide 10 has a longitudinal axis labelled as X in FIG. 1 extending between an ion inlet 11 and an ion outlet 12 of the ion transfer device. The distance between the ion inlet 11 and the ion outlet 12 along the longitudinal axis may be, for example, 8-15 mm. The ion transfer device 10 has a plurality of plate electrodes 100 and, in this exemplary arrangement, the ion transfer device has fourteen plate electrodes 100. The plate electrodes 100 are formed of an electrically conductive material. The plate electrodes 100 may be formed of, for example, stainless steel or an electrical conducting polymer. The plate electrodes 100 may be formed by, for example using a conventional a milling process or by an additive process, such as 3D printing. The accuracy of the mechanical alignment of the electrode assembly may be achieved by the precision of the 3D printed device. Such a manufacturing process will be lower in cost compared to manufacturing each electrode individually. Alternatively, the plate electrodes may be manufactured first by laser cutting and the protrusions may then be formed using 3D printing.

An RF voltage supply (not shown) is provided that is connected to the plate electrodes 100 such that RF voltages of opposite polarities are applied to each pair of adjacent plate electrodes 100 throughout the interface ion guide 100. Consequently, plate electrodes 100 having a positive RF voltage applied thereto are interleaved with plate electrodes 100 having a negative RF voltage applied thereto.

The plate electrodes 100 each have a plate 110 and an aperture 120 formed in the plate 110. Each plate 110 is planar and has two planar (major) surfaces, referred to herein as first and second planar surfaces 111i, ii. The plates 110 are spaced apart from each other along the longitudinal axis. Each planar surface 111i, 111ii of each plate 110 opposes and is spaced apart from the proximal planar surface of the adjacent plate 110 along the longitudinal axis X. The longitudinal axis X is normal/perpendicular to the planar surfaces 111i, 111ii of each plate 110. In this exemplary embodiment, each plate 110 has the same shape and dimensions and is rectangular but other shapes and dimensions are contemplated. The plate 110 of each plate electrode 100 may have a length of, for example, 8-30 mm. The plate 110 of each plate electrode 100 has a thickness that is approximately the same as the spacing between the plates 110 of the ion transfer device 10. The thickness of the plates 110 and the spacing between the plates may be approximately 0.2-1.5 mm.

For each plate electrode 100, the aperture 120 is formed within the planar surfaces of the plate 110. The aperture 120 is a through-hole in the plate and extends through the thickness of the plate 110. The aperture 120 is centred with the longitudinal axis X of the ion transfer device 10. The apertures 120 are aligned with each other thereby defining a continuous ion flow path therethrough. The aperture 120 is formed as a circle in the exemplary embodiment of FIG. 1 but other shapes are contemplated providing the aperture is centred along the longitudinal axis X of the ion transfer device 10. The diameter of the apertures 120 are sized to permit the passage of ions therethrough and may be, for example, 2-30 mm. The aperture 120 is defined by its periphery 121, which in this exemplary arrangement is circular in shape.

In this exemplary embodiment, each of the plates 110 of the plate electrodes 100 optionally have one or more openings 130 formed in the planar surfaces of the plates 110 as through-holes that provide a path for gas to flow therethrough. The one or more openings 130 minimize electrical capacitance of interface ion guide. The one or more openings 130 do not impinge the vacuum between the interface ion guide and the upstream SRIG because the gas limiting aperture will be the aperture of the most downstream plate electrode of the SRIG. In this exemplary embodiment, the openings 130 optionally have a smaller diameter than the diameter of the aperture 120 and are offset from the longitudinal axis. The openings 130 are optionally circumferentially arranged around the aperture 120.

In the exemplary embodiment shown in FIGS. 1 and 2, the plate electrodes 100 are grouped into sets of plate electrodes. In this exemplary embodiment, there are first, second, third and fourth 201, 202, 203, 204 sets of plate electrodes. The first, second and third sets 201, 202, 203 each having four plates electrodes 100a-100d and the fourth set 204 having two plate electrodes 100a, d. Alternative quantities of plate electrodes 100 within each set and alternative numbers of sets of plate electrodes 100 are contemplated. The spacing between the sets of plate electrodes is optionally the same as the spacing between adjacent plates 100 within each set of plate electrodes 100.

In the description below, the plate electrodes may be referred to generally with reference numeral 100 and the protrusion may be referred to generally with reference numeral 140 although it will be appreciated that the protrusions 140 differ in their positioning and configuration. To aid distinguishing the plate electrodes and protrusions of each set, in the figures, the suffix ′ is added to the reference numerals of plate electrodes, plates, apertures and protrusions within the first set, the suffix ″ is added to the reference numerals of plate electrodes and protrusions within the second set, the suffix ′″ is added to the reference numerals of plate electrodes, plates, apertures and protrusions within the third set and the suffix ″″ is added to the reference numerals of plate electrodes, plates, apertures and protrusions within the fourth set. To aid distinguishing the plate electrodes and protrusions within each set, in the figures, the suffix “a” is added to the reference numerals for most upstream plates, apertures and protrusions of the most upstream plate electrode within each set, the suffix “b” is added to the reference numerals of the plates, apertures and protrusions for next plate electrode along the longitudinal axis, the suffix “c” is added to the reference numerals for the plates, apertures and protrusions of the next plate electrode along the longitudinal axis and the suffix “d” is added to the reference numerals for the plate plates, apertures and protrusions of the most downstream plate electrode within the set. For example, the most upstream plate electrode within the first set of plate electrodes 201 is labelled as 100a′ and its protrusions labelled as 140a′.

The first set 201 of plate electrodes 100 is the most upstream set of plate electrodes and may define the ion inlet 11 of the interface ion guide 10. The nth set of plate electrodes 100, in this case the fourth set 204 of plate electrodes 100, is the most downstream set of plate electrodes 100 and may define the ion outlet 12 of the interface ion guide 10.

As shown in FIG. 1, the plate electrodes 100 may be held in their relative positions by a holder 30 configured to hold the plates of the plate electrodes in alignment with each other. As shown in FIG. 1, the plate electrodes 100 are held in place such that their plates 110 are parallel to each other and spaced apart from each other. The ion transfer device may have fixing means configured to fix each of the plate electrodes 100 within the holder 30. The fixing means may be coupled to/extend from a periphery of each plate 110 of the plate electrodes 20. As shown in the exemplary embodiment of FIG. 1, the fixing means may be one or more pins 31 extending from the periphery of each plate 100 that are received within corresponding openings 32 in the holder 30. The pins 31 may extend from opposing sides of the periphery of the respective plate 110. The holder 30 may only contact the plate electrodes 100 via the pins 31. The pins 31 may be integrally formed with the plates 110. The pins 31 may extend within the plane of the plate 110 (i.e. at zero degrees to the planar surface 111 of the plate 110). The pins 31 may be formed of an electrically conductive material, preferably the same material as the plate electrodes 100. The RF voltage supply may be connected to the plate electrodes via the pins 31. In the specific embodiment shown in FIG. 1, optionally three pins 31 are used to keep each plate electrode 100 in place within the holder 30. A first pin 31 extends from one edge of the plate 110 and second and third pins 31 extends from an opposing edge of the plate 110. The plate electrodes 100 may be aligned in their relative positions prior to mounting to the holder 30 using, for example, a mechanical gauge or other aligning device that may be removed after mounting the plate electrodes 100 within the holder 30. During manufacturing of the plate electrodes, if 3D printing is used to form the plate electrodes, the pins 31 may be coupled together via connecting bridges that can be removed after the plate electrodes have been connected to the holder 30. The parts of the holder 30 containing the corresponding openings 32 may be PCBs. The pins 31 may be connected to the PCBs of the holder 30 by, for example, soldering. Screws 35 of the holder 30 may be employed to align the set of plate electrodes 100, for example, relative to upstream and/or downstream ion optics.

Each plate electrode 100 has protrusions 140 extending from the periphery 121 of the respective aperture 120. Specifically, in this optional embodiment, the first to third sets 201, 202, 203 of plate electrodes 100 each have twelve protrusions 140 and the fourth set 204 of plate electrodes 100 has four protrusions 140. Other numbers of protrusions 140 for each set of plates 110 are contemplated.

When the plate electrodes 100 are assembled, as a set of plate electrodes, the protrusions 140 are equally spaced apart about the longitudinal axis X. Specifically, the twelve protrusions of the first, second and third sets 201, 202, 203 of plate electrodes 100 are spaced apart from each other by 30° about the longitudinal axis X. The four protrusions 140 of the fourth set 204 of plate electrodes 100 are spaced apart from each other by 90° about the longitudinal axis X.

Adjacent protrusions 140 within a set of plate electrodes 100 may form pairs of adjacent protrusions. Each pair of adjacent protrusions has a first protrusion 140 that is part of a plate electrode 100 configured to have an RF voltage applied thereto and a second protrusion 140 that is part of a plate electrode 100 configured to have an RF voltage that is out of phase with the RF voltage applied to the first protrusion 140, optionally that is 180 degrees out of phase with the RF voltage applied to the first protrusion. Consequently, in use adjacent protrusions 140 have voltages of opposite polarities applied thereto.

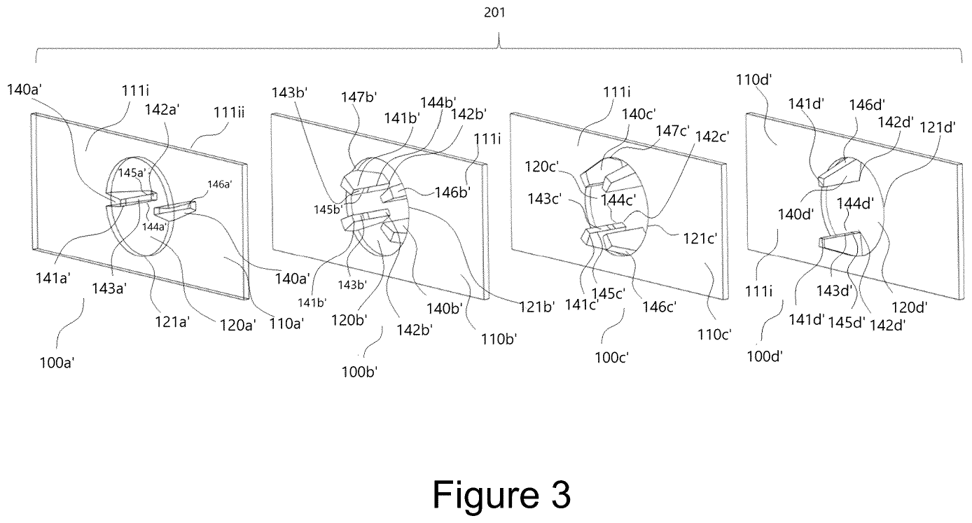

FIG. 3 is a schematic diagram of an exploded view of the first set of plate electrodes 201 where the plate electrodes 100′ are arranged from left to right in order from upstream to downstream i.e. the most upstream plate electrode 100′ is on the left of FIG. 3 and the most downstream plate electrode 100′ is on the right of FIG. 3.

In general, and as exemplified by FIG. 3, within each set of plate electrodes, the protrusions 140 extend longitudinally between a first end 141 and a second end 142 at a non-zero angle to the planar surface of the respective plate and radially inward from the periphery 121 of the respective aperture 120. The length of each protrusion 140 is between its first end 141 and its second end 142. The length of each protrusion 140 between the first end 141 and the second end 142 may be such that when the plate electrodes 100 are assembled as a set of plate electrodes 100, the first ends 141 of the protrusions 140 within the set align with each other and the second ends 142 of the protrusions align with each other. Each protrusion 140 has an inner surface 143 that is radially spaced from the periphery 121 of the aperture 120. The inner surface 143 has a length extending longitudinally at the non-zero angle and a width extending perpendicular to the length. The non-zero angle may be the angle between the length of the inner surface 143 and the planar surface 111 of the respective plate 110. As shown in FIG. 3, the length of the inner surface 143 extends parallel to the longitudinal axis X i.e. the non-zero angle to the planar surface 111 is approximately 90 degrees. The width of the inner surface 143 may be between a first edge 144 and a second edge 145 where the second edge 145 is opposite to the first edge 144 and the first and second edges 144, 145 and perpendicular to the first and second ends 141, 142. The width of the inner surface 143 of each protrusion defines the angular extent of each protrusion 140 about the longitudinal axis X. The angular extent may be specifically the angle between a radius from the longitudinal axis X to the first edge 144 and a radius from the longitudinal axis X to the second edge 145. The inner surface 143 is optionally planar (i.e. flat) in the embodiment of FIG. 1.

As discussed above, in FIG. 3, within the first set of plate electrodes 201, the most upstream plate electrode is labelled with reference numeral 100a′ and the most downstream plate electrode is labelled with reference numeral 100d′ with plate electrodes labelled as 100b′ and 100c′ therebetween. The protrusions of the first plate electrode 100a′ within the first set of plate electrodes 201 are labelled with reference numeral 140a′. The protrusions of the second plate electrode 100b′ within the first set of plate electrodes 201 are labelled with reference numeral 140b′. The protrusions of the third plate electrode 100c′ within the first set of plate electrodes 201 are labelled with reference numeral 140c′. The protrusions of the fourth plate electrode 100d′ within the first set of plate electrodes 201 are labelled with reference numeral 140d′.

In FIG. 3, the most upstream plate electrode 100a′ of the first set 201 of plate electrodes referred to herein as the first plate electrode 100a′ of the first set 201 optionally has two protrusions 140a′ that are optionally equally spaced apart around the longitudinal axis (i.e. spaced apart by 180°). Each protrusion 140a′ of the first plate electrode 100a′ extends longitudinally from the periphery 121 of the aperture 120 towards the ion outlet 12 (i.e. towards the other plate electrodes 100 within the first set 201 of plate electrodes 100). This is so that, when assembled as a set of plate electrodes, the protrusions 140a′ extend longitudinally through the apertures 120 of all plate electrodes 100 within the first set 201 (i.e. through the apertures 120a′, 120b′, 120c′, 120d′ of the second, third and fourth plate electrodes 100b′, 100c′, 100d′ within the first set 201). The first end 141a′ of each protrusion 140a′ of the first plate electrode 100a′ is proximal to the periphery 121 of the aperture 120 and the second end 142a′ is distal from the periphery 121 of the aperture 120. As discussed above, the plate 110 has first and second planar surfaces 111i, ii. Herein, the first planar surface 111i is upstream of the second planar surface 111ii. Each protrusion 140a′ of the first plate electrode 100a′ optionally does not extend beyond the first planar surface 111i. When provided as a set 201 of plate electrodes 100′, the second end 142a′ of each protrusion of the first plate electrode 110a is proximal to the periphery 121 of the aperture 120 of the final plate electrode 100 within the set 201 of plate electrodes 100′ (i.e. the fourth plate electrode 100d). The protrusions 140a′ are optionally configured such that the radial distance between the outer surface 146a′ of the protrusion and the periphery 121 of the apertures 120 of the plate electrodes 100 increases with (longitudinal) distance from the periphery 121 of the respective aperture 120. Specifically, the protrusions 140a′ of the first plate electrode 100a′ of the first set 201 are tapered between their first end 141a′ and their second end 142a′ such that the distance along the radial direction between the outer surface 146 of the protrusion 140a′ and the periphery 121 of the apertures 120 of the plate electrodes 100 within the respective set 201 of plate electrodes 100′ increases from its first end 141a′ proximal to the periphery 121 of the respective aperture 120a′ to its second end 142a′ distal from the respective aperture 120. The width of the inner surface 143 of the protrusions 140a′ of the first plate electrode 100a′ (i.e. between the first edge 144 and the second edge 145 of the inner surface 143) is such that the angular extent of the protrusions 140a′ is approximately 10 degrees. As discussed above, the angular extent is the angle between a radius from the longitudinal axis X to the first edge 144a′ and a radius from the longitudinal axis X to the second edge 145a′. The protrusions 140a′ of the first plate electrode 100 are also tapered between their outer surface 146a′ and their inner surface 143a′ i.e. along the radial direction such that the width of the outer surface 146a′ is greater than the width of the inner surface 143a′ (forming a wedge shape).

The second plate electrode 100b′ of the first set 201 of plate electrodes 100, which is adjacent to and downstream of the first plate electrode 100a′ optionally has four protrusions 140b′ that are spaced apart around the longitudinal axis X unequally. The spacing between adjacent protrusions 140b′ alternates between approximately 60 and approximately 120 degrees about the longitudinal axis X.

Each protrusion 140b′ of the second plate electrode 100b′ extends longitudinally from the periphery 121b′ of the aperture 120b′ towards both the ion inlet 11 and the ion outlet 12 (i.e. towards all of the other plate electrodes 100′ within the set 201 of plate electrodes 100). This is so that, when assembled as a set 201 of plate electrodes 100′, the protrusions 140b′ extend longitudinally through the apertures 120 of all plate electrodes 100 within the first set 201. Each protrusion 140b′ of the second plate electrode 100b′ contacts or extends from or is joined to the periphery 121b′ of the aperture 120b′ of the plate 110b′ of the second plate electrode 100b′ at an intermediate point 147b′ between its first end 141b′ and its second end 142b′. As shown in FIG. 3, the intermediate point 147b′ is closer to the first end 141b′ (upstream end) than the second end 142b′ (downstream end). When assembled as a set 201 of plate electrodes 100′, the first end 141b′ of each protrusion 140b′ of the second plate electrode 100b′ would be proximal to the periphery 121a′ of the aperture 120a′ of the first plate electrode 100a′ and the second end 142b′ would be proximal to the periphery 121d′ of the aperture 120d′ of the fourth plate electrode 100d′. Accordingly, each protrusion 140b′ of the second plate electrode 110b′ extends beyond the first and second planar surfaces 111i, ii of the plate 110b′ of the second plate electrode 100b′. The non-zero angle between the planar surface 111i, ii and the inner surface 143b′ of the protrusions 140b′ of the second plate electrode 100b′ is approximately 90 degrees such that the inner surface 143b′ is approximately parallel to the longitudinal axis X. The protrusions 140b′ are optionally configured such that the radial distance between the outer surface 146b′ of the protrusion 140b′ and the periphery 121a,b,c,d′ of the apertures 120 of the plate electrodes 100′ increases with (longitudinal) distance from the periphery 121b′ of the respective aperture 120b′. The width of the inner surface 143b′ of the protrusions 140b′ of the second plate electrode 100b′ (i.e. between the first edge 144b′ and the second edge 145b′ of the inner surface 143b′) is such that the angular extent of the protrusions 140b′ is approximately 10 degrees. As discussed above, the angular extent is the angle between a radius from the longitudinal axis to the first edge 144b′ and a radius from the longitudinal axis to the second edge 145b′. The protrusions 140b′ of the second plate electrode 100b′ are also tapered between their outer surface 146b′ and their inner surface 143b′ i.e. along the radial direction such that the width of the outer surface 146b′ is greater than the width of the inner surface 143b′ (forming a wedge shape).

The third plate electrode 100c′ of the first set of plate electrodes 201, which is adjacent to and downstream of the second plate electrode 100b′ optionally has four protrusions 140c′ that are spaced apart around the longitudinal axis X unequally. The spacing between adjacent protrusions 140c′ alternates between approximately 60 and approximately 120 degrees about the longitudinal axis X. The protrusions 140c′ of the third plate electrode 100c′ are configured similarly to those of the second plate electrode 100b′ as discussed above except that the intermediate point 147c′ is closer to the second end 142c′ (downstream end) of the protrusion 140c′ than the first end 141c′ (upstream end) and that the protrusions 140c′ are positioned about the longitudinal axis X such that, when assembled together, the protrusions 140b′ of the second plate electrode 100b′ are spaced apart by 30 degrees from the protrusions 140c′ of the third plate electrode 100c′.

The fourth plate electrode 100d′ of the first set 201 of plate electrodes 100′, which is adjacent to and downstream of the third plate electrode 100c′ optionally has two protrusions that are spaced apart around the longitudinal axis X equally (by 180 degrees). The protrusions 140d′ of the fourth plate electrode 100d′ are configured similarly to those of the first plate electrode 100a′ as discussed above except that the protrusions 140d′ of the fourth plate electrode 100d′ do not extend beyond the downstream (second) planar surface 111ii of the plate 110 and instead extend longitudinally in an upstream direction i.e. towards the other plate electrodes 100′ within the set 201 of plate electrodes 100. The protrusions 140d′ of the fourth plate electrode 100d′ extend from the second end 142d′ proximal to the periphery 121 of the respective aperture 120 of the fourth plate electrode 100d′ to the first end 141d′ distal from the periphery 121d′ of the respective aperture 120d′. Each protrusion 140d′ of the fourth plate electrode 100d extends longitudinally through the apertures 120a′,b′,c′ of the second, third and first plate electrodes 100b′, 100c′, 100a′ when assembled together as a set of plate electrodes. When provided as a set of plate electrodes, the first end 141d′ of each protrusion 140d′ of the fourth plate electrode 100d′ is proximal to the periphery 121a′ of the aperture 120a′ of the first plate electrode 100a′ within the set 201 of plate electrodes 100′. The protrusions 140d′ of the fourth plate electrode 100d′ also differ from those of the first plate electrode 100a′ in that the protrusions 140d′ are positioned about the longitudinal axis X such that, when assembled together, the protrusions 140d′ of the fourth plate electrode 100d′ are spaced apart by 90 degrees about the longitudinal axis from the protrusions 140a′ of the first set of plate electrodes 100a′.

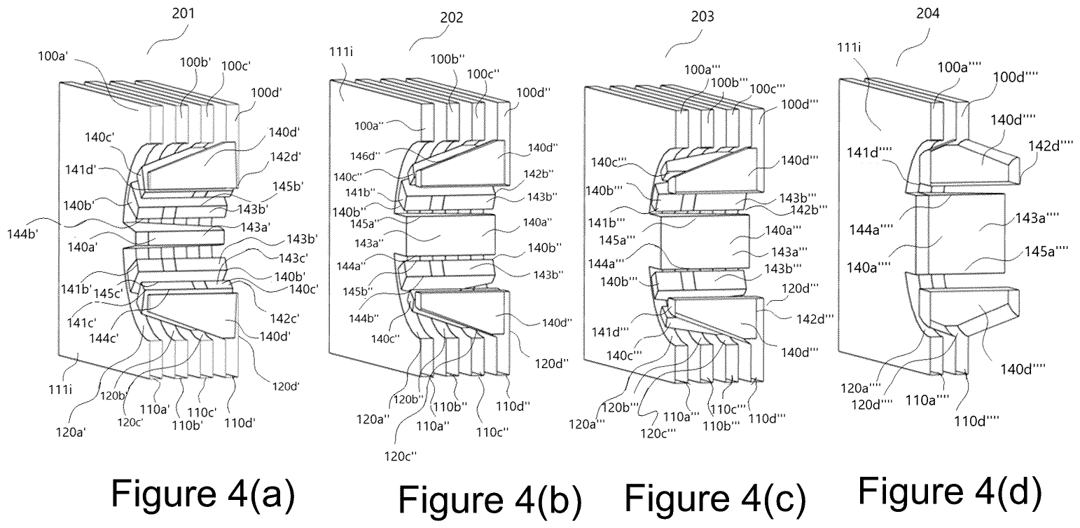

When assembled together as a set of plate electrodes, as shown in the sectional view of FIG. 4(a), the protrusions 140′ of the first set of plate electrodes 201 are equally spaced apart about the longitudinal axis by 30 degrees. The protrusions 140′ all extend longitudinally within the apertures 120′ of all plate electrodes 100′ within the set 201 of plate electrodes 100′. Each pair of adjacent protrusions 140′ within the set of plate electrodes having a first protrusion 140′ extending from a plate electrode 100′ having an RF voltage applied thereto and a second protrusion 140′ extending from a plate electrode 100 having an RF voltage of opposite polarity applied thereto. For example, the first plate electrode 100a′ and the third plate electrode 100c′ may have an RF voltage applied thereto that is opposite in polarity to the RF voltage applied to the interleaved second and fourth plate electrodes 100b′, 100d′. In the exemplary embodiment of FIG. 4(a), each protrusion 140a′ of the first plate electrode 100a′ is optionally between and so adjacent to protrusions 140b′ of the second plate electrode 100b′. Each protrusion 140b′ of the second plate electrode 100b′ is optionally between and so adjacent to a protrusion 140a′ of the first plate electrode 100a′ and a protrusion 140c′ of the third plate electrode 100c′. Each protrusion 140c′ of the third plate electrode 100c′ is optionally between and so adjacent to a protrusion 140b′ of the second plate electrode 100b′ and a protrusion 140d′ of the fourth plate electrode 100d′. Each protrusion 140d′ of the fourth plate electrode 100d′ is optionally between and so adjacent to protrusions 140c′ of the third plate electrode 100c′. Consequently, in use, the pairs of adjacent protrusions 140′ will have RF voltages of opposite polarities applied thereto.

Four of the twelve protrusions 140′ of the first set 201 of plate electrodes 100′ are referred to herein as primary protrusions and are spaced 90 degrees apart from each other about the longitudinal axis and would generate a quadrupole RF field if provided in isolation of the remaining eight protrusions referred to herein as the secondary protrusions. Each primary protrusion is optionally centred at a position about the longitudinal axis X that is aligned with a midpoint of an edge of the plate 110. The width of the inner surface 143 of the primary protrusion is parallel to an edge of the plate 110. As discussed above, the plate 110 is optionally formed in a rectangular shape and so has four edges that are perpendicular to each other.

In this exemplary embodiment, the primary protrusions within the first set of plate electrodes 201 extend from the first and fourth plate electrodes 100a′, 100d′ and so are the protrusions labelled with reference numerals 140a′, 140d′. In this exemplary embodiment, the secondary protrusions within the first set of plate electrodes 201 extend from the second and fourth plate electrodes 100b′, 100c′ and so are the protrusions labelled with reference numerals 140b′, 140c′. However, the primary protrusions may extend from any of the plate electrodes 100 providing they are spaced 90 degrees apart from each other about the longitudinal axis X when assembled within the set of plate electrodes.

Similarly, the secondary protrusions may extend from any of the plate electrodes. Nevertheless, for consistency with the labelling in the figures, the primary protrusions within the first set 201 will be labelled herein with reference numerals 140a′, 140d′ and the secondary protrusions within the first set 201 will be labelled herein with reference numerals 140b′, 140c′.

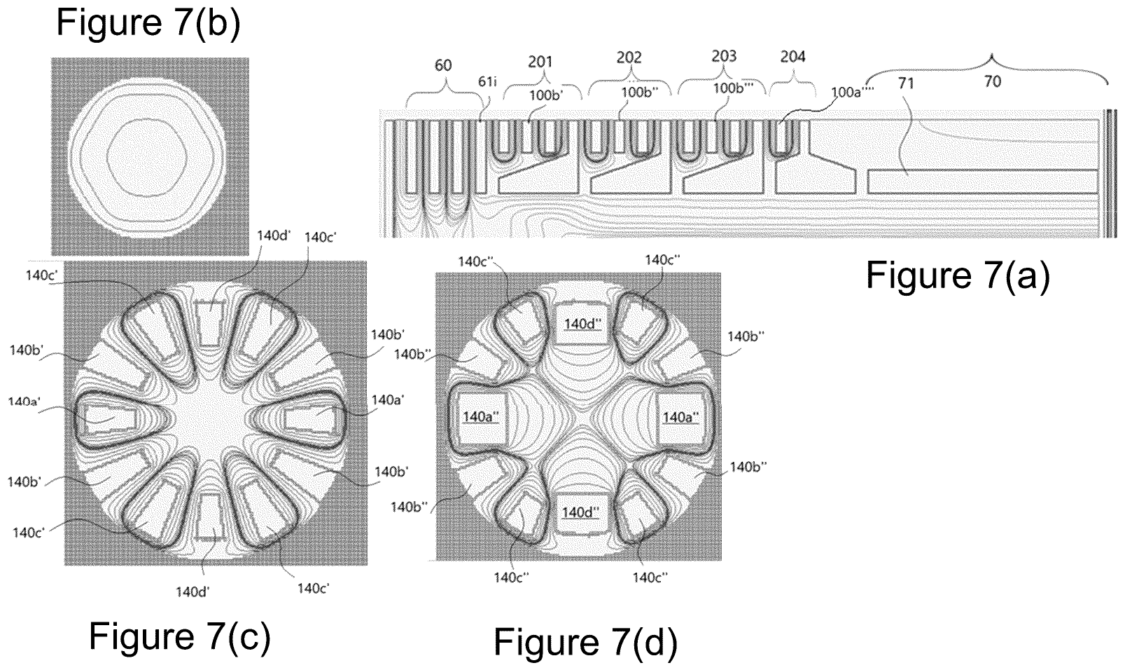

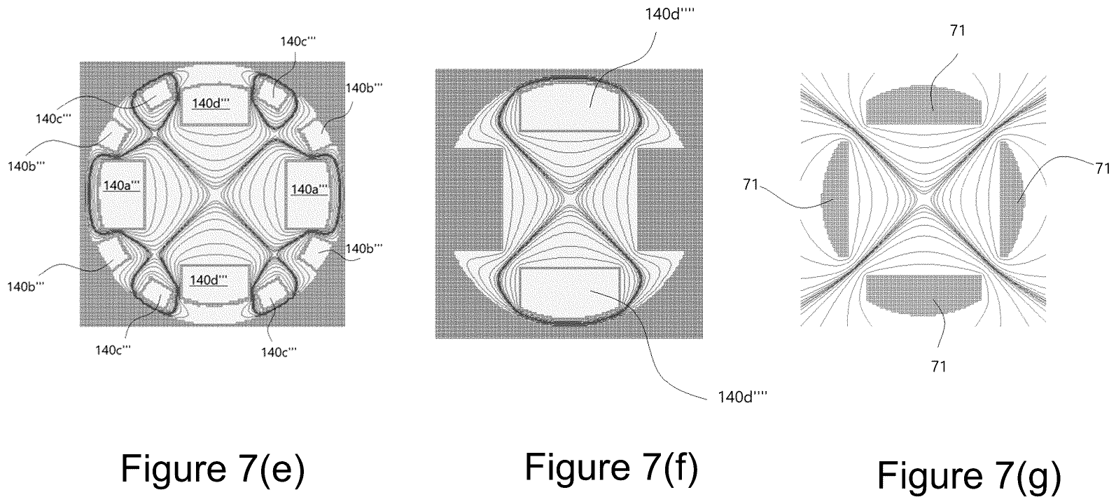

For the first set of plate electrodes 100, the primary protrusions 140a′ 140d′ and secondary protrusions 140b′, 140c′ equally contribute to the RF field generated as their inner surfaces 143 have the same width (i.e. the same angular extent) and the same radial distance to the longitudinal axis X. Therefore, when RF voltages of opposite polarities are applied to pairs of adjacent plate electrodes 100′ within the first set 201 of plate electrodes 100′ (i.e. such that the first and third plate electrodes 100a′, 100c′ have an RF voltage of the same polarity applied thereto that is opposite in polarity to the RF voltage applied to the second and fourth plate electrodes 100b′, 100d′), a regular dodecapole RF field is generated as shown best by the potential energy diagram of FIG. 7(c), which is discussed in further detail below.

FIGS. 4(a) to (d) are schematic diagrams of sectional views of each of the first, second, third and fourth sets 201, 202, 203, 204 of plate electrodes 100 of the interface ion guide 10, respectively, of FIG. 1.

The plate electrodes 100′ of the first set 201 of plate electrodes 100′ have been discussed above in the context of FIG. 3 but are shown as assembled together in FIG. 4(a).

FIG. 4(b) is a schematic diagram of a sectional view of the second set 202 of plate electrodes 100″ of the interface ion guide 10 of FIG. 1.

The second set 202 of plate electrodes 100″ are similar to the first set 201 of plate electrodes 100′ described above except that the primary protrusions (labelled with reference numerals 140a″ and 140d″) have a wider inner surface (and so greater angular extent) than the corresponding primary protrusions of the first set 201 of plate electrodes 100 (labelled with reference numerals 140a′ and 140d′) and the secondary protrusions (labelled with reference numerals 140b″ and 140c″) have a smaller radial distance from their inner surface 143 to the longitudinal axis X than the corresponding secondary protrusions of the first set 201 of plate electrodes 100′ (labelled with reference numerals 140b′ and 140c′). By “corresponding protrusions”, this refers to protrusions 140 belonging to different sets of plate electrodes that are centred at the same angular position about the longitudinal axis X.

As can be seen in FIG. 4(b), the width of the inner surface 143a″, 143d″ of the primary protrusions 140a″, 140d″ of the second set 202 of plate electrodes 100″ is such that the angular extent of the inner surface 143a″, 143d″ of these primary protrusions 140a″ is approximately double that of the corresponding primary protrusions 140a′, 140d′ of the first set 201 of plate electrodes 100′ and also double that of the secondary protrusions 140b″, 140c″ of the second set 202 of plate electrodes 100b″. As discussed above, the angular extent may be specifically the angle between a radius from the longitudinal axis X to the first edge 144 and a radius from the longitudinal axis X to the second edge 145 of the inner surface 143.

In this specific arrangement, the inner surfaces 143″ of the primary protrusions 140a″,d″ of the second set of plate electrodes 202 has an angular extent of approximately 20 degrees about the longitudinal axis X. The primary protrusions 140a″, 140d″ of the second set of plate electrodes 202 are no longer tapered between their outer surface 146a″, 146d″ and inner surface 143a″, 143d″ (i.e. no longer formed as a wedge shape) such that their outer surface 146a″, 146d″ and inner surface 143a″, 143d″ have the same width. These primary protrusions 140a″, 140d″ are also optionally no longer tapered between their first end 141a″, 141d″ and their second end 142a″, 142d″ as best shown in FIG. 2.

As best seen by comparing FIG. 4(b) to FIG. 4(a) and briefly discussed above, the second set 202 of plate electrodes 100″ differs from the first set 201 of plate electrodes 100′ as the secondary protrusions 140b″, 140c″ of the second set 201 of plate electrodes 100″ have a smaller radial distance from their inner surface 143b″, 143c″ to the longitudinal axis X than the corresponding secondary protrusions 140b′, 140c′ of the first set 201 of plate electrodes 100′. In this exemplary embodiment, all of the secondary protrusions 140b″, 140c″ of the second set 202 of plate electrodes 100″ have a smaller radial distance from their inner surface 143b″, 143c″ to the longitudinal axis X than the corresponding secondary protrusions 140b′, 140c′ of the first set 201 of plate electrodes 100′. However, it is contemplated that only some of the secondary protrusions 140b″, 140c″ may have a smaller radial distance from their inner surface 143b″, 143c″ to the longitudinal axis X than the corresponding secondary protrusions 140b′, 140c′ of the first set 201 of plate electrodes 100′. The smaller radial distance between the inner surface 143 to the longitudinal axis X may be achieved by reducing how far the protrusion 140 extends radially inward from the periphery 121 of the aperture 120 i.e. the reducing the radial dimension of the protrusion 140.

In this exemplary embodiment, the secondary protrusions 140b″, 140c″ are centred at a position about the longitudinal axis X that is offset from a midpoint of an edge of the plate 110b″, 110c″. As discussed above, the plate 110b″, 110c″ is optionally formed in a rectangular shape and so has four edges that are perpendicular to each other. The secondary protrusions 140b″, 140c″ are optionally positioned about the longitudinal axis X at approximately 30 or approximately 60 degrees from each other.

For the second set 202 of plate electrodes 100″, the primary protrusions 140a″, 140d″ contribute to the RF field generated more than the secondary protrusions 140b″, 140c″ as their inner surfaces 143a″, 143d″ have a greater width (i.e. greater angular extent) and a smaller radial distance to the longitudinal axis X. Therefore, when RF voltages of opposite polarities, are applied to pairs of adjacent plate electrodes 100″ within the second set 202 of plate electrodes 100″ (i.e. such that the first and third plate electrodes 100a″, 100c″ have an RF voltage of the same polarity applied thereto that is opposite in polarity to the RF voltage applied to the second and fourth plate electrodes 100b″, 100d″), an irregular dodecapole RF field is generated. The irregular dodecapole RF field generated has a reduced acceptance area compared to the regular dodecapole RF field generated by the first set 201 of plate electrodes 100′ as shown by comparing the potential energy diagram of FIG. 7(d), which illustrates the RF field that would be generated by the second set 202 of plate electrodes 100″ to FIG. 7(c), which illustrates the RF field that would be generated by the first set 201 of plate electrodes 100″.

The third set 203 of plate electrodes 100″ are similar to the second set 202 of plate electrodes 100″ described above except that the primary protrusions 140a′″, 140d′″ have a wider inner surface 143a″, 143d′″ (and so greater angular extent) than the corresponding primary protrusions 140a″, 140d″ of the second set 202 of plate electrodes 100″ and the secondary protrusions 140b″, 140c′″ have a smaller radial distance from their inner surface 143b′″, 143c′″ to the longitudinal axis X than the corresponding secondary protrusions 140b″, 140c″ of the second set 202 of plate electrodes 100″. For the third set 203 of plate electrodes 100″, the primary protrusions 140a″, 140d″ contribute to the RF field generated more than the secondary protrusions 140b′″, 140c′″ as their inner surfaces 143a′″, 143d′″ have a greater width (i.e. greater angular extent) and a smaller radial distance to the longitudinal axis X. The primary protrusions 140a′″, 140d′″ of the third set 203 of plate electrodes 100′″ contribute to the RF field generated by the third set 203 of plate electrodes 100″ more than the primary protrusions 140a″, 140d″ of the second set 202 of plate electrodes 100″ contributes to the RF field generated by the second set 202 of plate electrodes 100″. The secondary protrusions 140b′″, 140c′″ of the third set 203 of plate electrodes 100′″ contribute to the RF field generated by the third set 203 of plate electrodes 100″ less than the secondary protrusions 140b″, 140c″ of the second set 202 of plate electrodes 100″ contributes to the RF field generated by the second set 202 of plate electrodes 100″.

Therefore, when RF voltages of opposite polarities are applied to pairs of adjacent plate electrodes 100 within the third set 203 of plate electrodes 100″ (i.e. such that the first and third plate electrodes 100a′″, 100c″ have an RF voltage of the same polarity applied thereto that is opposite in polarity to, the RF voltage applied to the second and fourth plate electrodes 100a, 100d), an irregular dodecapole RF field is generated. The irregular dodecapole RF field generated by the third set 203 of plate electrodes 100′″ has a reduced acceptance area compared to the irregular dodecapole RF field generated by the second set 202 of plate electrodes 100″ as shown by comparing the potential energy diagram of FIG. 7(e), which illustrates the RF field that would be generated by the third set 203 of plate electrodes 100 to FIG. 7(d), which illustrates the RF field that would be generated by the second set 202 of plate electrodes 100″.

The fourth set 204 of plate electrodes 100″″ is similar to the third set 203 of plate electrodes 100′″ described above except that there are only two plate electrodes, which are labelled with reference numerals 100a″″, 100d″″, the secondary protrusions are not present and the primary protrusions 140a″″, 140d″″ have a wider inner surface 143a″″, 143d″″ (and so greater angular extent) than the corresponding primary protrusions 140a′″, 140d″ of the third set 203 of plate electrodes 100′″. The fourth set 204 of plate electrodes 100″″ therefore only has the four primary protrusions 140a″″, 140d″″ and so generates a regular quadrupole RF field when RF voltages of opposite polarities are applied to adjacent pairs of the plate electrodes 100″. The two plate electrodes of the fourth set of plate electrodes 100″″ are referred to herein as first and second plate electrodes and labelled with reference numerals 100a″″, 100d″″.

When the four sets of plate electrodes are assembled together, the last (i.e. most downstream) plate electrode 100 of each set of plate electrodes 100 has an RF voltage applied thereto that is of opposite polarity to the RF voltage applied to the first (i.e. most upstream) plate electrode 100 of the adjacent downstream set of plate electrodes. For example, the last plate electrode 100d′ of the first set 201 of plate electrodes 100′ has an RF voltage applied thereto that is of opposite polarity to the RF voltage applied to the first plate electrode 100a″ of the second set 202 of plate electrodes 100″. The spacing between each set of plate electrodes is optionally the same as the spacing between each plate electrode 100 within the set of plate electrodes 100 as shown in FIG. 2.

In use, a DC voltage may be applied to one or more of the plate electrode(s) 100 to form a DC field gradient along the longitudinal axis driving ions from the first set 201 of plate electrodes 100 to the final set 204 of plate electrodes 100 and out of the interface ion guide 10. For example, a DC voltage may be applied to all of the plate electrode(s) 100 where a higher DC voltage is applied with increasing distance along the longitudinal axis X from the first plate electrode 100a.

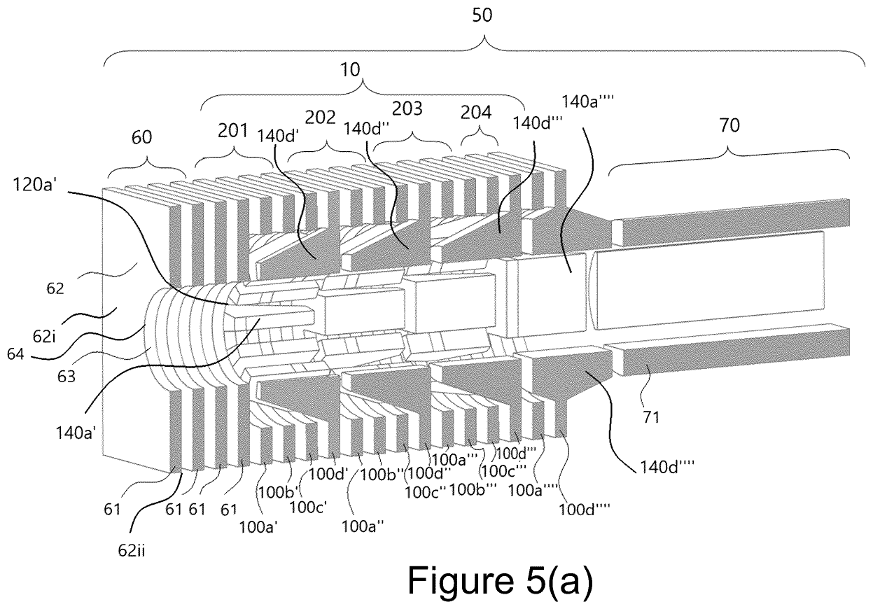

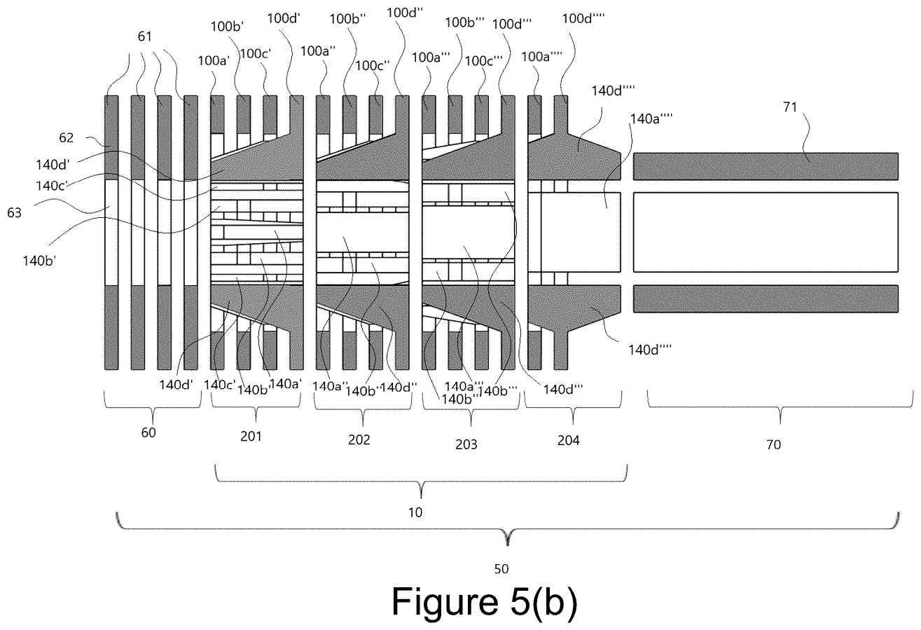

FIGS. 5(a) and (b) are a schematic diagrams of a longitudinal section of an ion transfer assembly 50 according to an exemplary embodiment of the claimed invention, the ion transfer assembly comprising the interface ion guide 10 of FIG. 1, a SRIG 60 and a downstream RF multipole ion guide 70 where the SRIG 60 is upstream of the interface ion guide 10 and the interface ion guide 10 is upstream of the downstream RF multipole ion guide 70. The ion transfer device 10 has a longitudinal axis X that is aligned with/co-axial with the longitudinal axis X of the interface ion guide 10 and the longitudinal axis X of the SRIG and the longitudinal axis X of the downstream RF multipole ion guide 70. The ion transfer assembly 50 may have a housing (not shown) having an entrance aperture and an exit aperture, each of the entrance aperture and exit aperture being centred with the longitudinal axis X and configured to transmit ions therethrough.

The SRIG 60 and interface ion guide 10 are optionally provided within the same housing. The SRIG 60 and the interface ion guide 10 may be provided in differential pumping stages within the same housing. The differential pumping stages may be separated by the downstream RF plate electrodes of the SRIG and a seal such that a pressure difference between the differential pumping stages may be maintained. In use, the pressure of the differential pumping stage containing the SRIG 60 would be higher than the pressure of the differential pumping stage containing the interface ion guide 10. The SRIG 60 and the interface ion guide 10 may be mounted within the same holder 30. This offers a more simple and cheaper assembly. Insulating material (not shown) may optionally be provided in between the SRIG 60 and the interface ion guide 10 (i.e. between the most downstream plate electrode 61 of the SRIG 60 and the most upstream plate electrode 100 of the interface ion guide 10). The insulating material may facilitate gas restriction used to lower the gas load from the pumping stage of the SRIG towards the pumping stage of the interface ion guide 10.

A capillary (not shown) optionally extends though the entrance aperture, such that ions may be introduced from the ion source into the SRIG housing via the capillary. The capillary is optionally co-axial with the longitudinal axis of the SRIG 60 and so aligned with the apertures of the SRIG plate electrodes 61 and interface ion guide plate electrodes 100. In an alternative arrangement, the entrance aperture (and the capillary) may be misaligned (i.e. not co-axial) with the apertures of the SRIG plate electrodes 61 and the apertures of the interface ion guide plate electrodes 100, and so off-centre from the longitudinal axis of the SRIG 60. In addition, the capillary may be at an angle to the longitudinal axis of the SRIG 60. The description of the interface ion guide 10 above equally applies to the interface ion guide 10 employed in FIG. 5.

The SRIG 60 has a plurality of SRIG plate electrodes 61. The SRIG plate electrodes 61 are formed of an electrically conductive material, which may be the same material as the plate electrodes 100 of the interface ion guide 10.

The SRIG plate electrodes 61 may have the same thickness as plates 110 of the interface ion guide 10 except that the SRIG plate electrodes 61 do not have protrusions. Nevertheless, for completeness, the SRIG plate electrodes 61 are described in detail below.

The SRIG plate electrodes 61 each have a plate 62 and an aperture 63 formed in the plate 62. Each plate 62 is planar and has two planar (major) surfaces, referred to herein as first and second planar surfaces 62i, 62ii. The SRIG plate electrodes 61 and so the plates 62 of the SRIG plate electrodes 61 are spaced apart from each other along the longitudinal axis. Each planar surface of each plate 62 opposes and is spaced apart from the proximal planar surface of the adjacent plate 62 along the longitudinal axis X. The longitudinal axis X is normal/perpendicular to the planar surfaces 62i, 62ii of each plate 62. In this exemplary embodiment, each plate 62 has the same shape and dimensions and is rectangular but other shapes and dimensions are contemplated. The plate 62 of each SRIG plate electrode 61 may have a length of, for example, 8-30 mm. The plate of each SRIG plate electrode 61 has a thickness that is approximately the same as the spacing between the plates 110 of the ion transfer device 10. The thickness of the plates 61 and the spacing between the plates 62 may be approximately 0.2-0.8 mm. The thickness of the plates 61 and the spacing between the plates 62 of the SRIG plate electrode 61 may be the same and the thickness of the plates 110 and the spacing between the plates 110 of the interface ion guide 10.

For each SRIG plate electrode 61, the aperture 63 is formed within the planar surfaces 62i, 62ii of the plate 62. The aperture 63 is a through-hole in the plate 62 and extends through the thickness of the plate 62. The aperture 63 is centred with the longitudinal axis X of the SRIG and so also with the longitudinal axis of the ion transfer assembly 50. The apertures 63 are aligned with each other and also with the apertures 120 of the ion transfer device 10 thereby defining a continuous ion flow path therethrough. Each aperture 63 is formed as a circle in the exemplary embodiment of FIG. 1 but other shapes are contemplated providing the aperture 63 is centred along the longitudinal axis X of the SRIG 60. The diameter of the apertures 63 are sized to permit the passage of ions therethrough and may be, for example, 2-15 mm. The aperture 63 is defined by its periphery 64, which in this exemplary arrangement is circular in shape. As shown in FIG. 5, the apertures 63 of the SRIG plate electrodes 61 are optionally of the same shape as the apertures 120 of the interface ion guide plate electrodes 100. The apertures 63 of the SRIG plate electrodes are of a similar, preferably the approximately the same diameter as the diameter of the channel formed by the protrusions of the interface ion guide plate electrodes 100.

The plates 62 of the SRIG plate electrodes optionally have one or more additional openings (not shown) formed in the planar surface that provide a path for gas to flow therethrough, similarly to the plates 110 of the plate electrodes 100 of the interface ion guide 10. The one or more additional openings minimize electrical capacitance of the SRIG, lead to reduced weight of the SRIG and also improve pumping speed when differentially pumping the SRIG and the interface ion guide.

As discussed above, the SRIG may be mounted within the same holder 30 as the interface ion guide 10. The SRIG may have SRIG fixing means (not shown) configured to fix each of the SRIG plate electrodes 61 within the holder 30. As discussed above, the holder 30 may contain one or more PCB(s) and the SRIG fixing means may be configured to fix the SRIG to the PCB(s) of the holder 30. The fixing means may be coupled to/extend from a periphery of each plate 62 of the SRIG plate electrodes 61. Similarly to the plate electrodes 100 of the ion transfer device 10, the fixing means may be one or more pins, referred to herein as SRIG pins, extending from the periphery of each SRIG plate 62 that are received within corresponding openings in the holder 30. The pins may extend from opposing sides of the periphery of the respective plate 62. The holder 30 may only contact the SRIG plate electrodes 61 via the SRIG pins. The SRIG pins may be integrally formed with the SRIG plates 62. The SRIG pins may extend within the plane of the SRIG plate 62 (i.e. at zero degrees to the planar surface 62i, ii of the SRIG plate 62). The SRIG pins may be formed of an electrically conductive material, preferably the same material as the SRIG plate electrodes 61. The RF voltage supply may be connected to the SRIG plate electrodes 61 via the SRIG pins. The SRIG pins may be connected to the PCBs of the holder 30 by, for example, soldering.

In use, the pumping stage containing the SRIG plate electrodes may be at atmospheric pressure and the pumping stage containing the interface ion guide may be pumped to reduce its pressure to less than 10 mbar, preferably less than 1 mbar, more preferably less than 0.1 mbar.

The individual plate electrodes of the SRIG and the individual plate electrodes of the interface ion guide are coupled to an RF voltage supply and optionally also to a DC voltage supply optionally via the respective pins. In one arrangement the pins are electrically coupled to the PCBs forming part of the holder 30 via which the RF voltage and DC voltage may be independently supplied to each plate electrode. An RF voltage supply is provided that is connected to the SRIG plate electrodes 61 such that RF voltages of opposite polarities are applied to each pair of adjacent plate electrodes throughout the SRIG 60. Consequently, SRIG plate electrodes 61 having a positive RF voltage applied thereto are interleaved with SRIG plate electrodes 61 having a negative RF voltage applied thereto. The spacing between the interface ion guide 10 and the SRIG 60 along the longitudinal axis X may be the same as the thickness of the plate electrodes 100 of the SRIG 60. Consequently, the same phase of the RF voltage supply may be connected to the plate electrodes 100 of the interface ion guide and the RF voltage applied to the plate electrodes 100 of the interface ion guide 10 may be of the same frequency and/or amplitude as the RF voltage applied to the SRIG plate electrodes 61. As discussed above, the RF voltage supply is connected to the plates of the interface ion guide such that RF voltages of opposite polarities are applied to each pair of adjacent plate electrodes throughout the interface ion guide. The most downstream SRIG plate electrode 61 i.e. the SRIG plate electrode 61 proximal/adjacent to the first plate electrode/most upstream plate electrode 100 of the interface ion guide 10 has an RF voltage of applied thereto that it of opposite polarity to the RF voltage applied to the first/most upstream plate electrode 100 of the interface ion guide 10.

As shown in FIG. 5, optionally the ion transfer assembly 50 comprises a downstream RF multipole ion guide 70. The downstream RF multipole ion guide 70 would be well known in the art. The downstream RF multipole ion guide 70 has a longitudinal axis that is aligned with/co-axial with the longitudinal axis X of the ion transfer assembly 50, the longitudinal axis X of the SRIG 60 and the longitudinal axis X of the interface ion guide 10. The downstream RF multipole ion guide 70 has a plurality of rods (rod electrodes) 71 extending along the longitudinal direction that are arranged about the longitudinal axis X. In other words, the rods 71 are elongate along the longitudinal direction. In this arrangement, the downstream RF multipole ion guide 70 has four rods 71 that are equally spaced apart about the longitudinal axis X. The four rods 71 are configured to generate a regular quadrupole RF field when pairs of adjacent rods have RF voltages of opposite polarity applied thereto i.e. when the first rod of the pair of adjacent rods has an RF voltage applied thereto that is opposite in polarity to the RF voltage applied to the second rod within the pair of adjacent rods. The downstream RF multipole ion guide 70 is optionally downstream of and coupled to the interface ion guide 10 such that ions exiting the interface ion guide 10 are transmitted to the downstream RF multipole ion guide 70. The downstream RF multipole ion guide 70 may have a housing, referred to herein as downstream multipole housing having an entrance aperture and an exit aperture. The entrance aperture may be coupled to the exit aperture of the interface housing. The downstream RF multipole 70 may be coupled to the interface ion guide 10 via a load-lock. The downstream RF multipole may be at the same or higher pressure than the interface ion guide. The downstream RF multipole 70 may be coupled to a mass analyser (not shown) and configured to transmit ions to the mass analyser.

In a preferred embodiment, the RF voltage applied to the rod electrodes 71 of the downstream RF multipole 70 is of the same frequency to the RF voltage applied to the SRIG plate electrodes 61 and the interface ion guide plate electrodes 100 such that no additional DC lens is required between the SRIG 60, downstream RF multipole 70 or interface ion guide 10. The amplitude of the RF voltage applied to each of the downstream RF multipole 70, SRIG 60 and interface ion guide 10 may be different.

A single RF voltage supply connected to the SRIG 60, interface ion guide 10 and the downstream RF multipole 70 may be employed with voltage dividers. Alternatively, the downstream RF multipole 70 may be connected to a separate RF voltage supply from the SRIG and the interface ion guide.

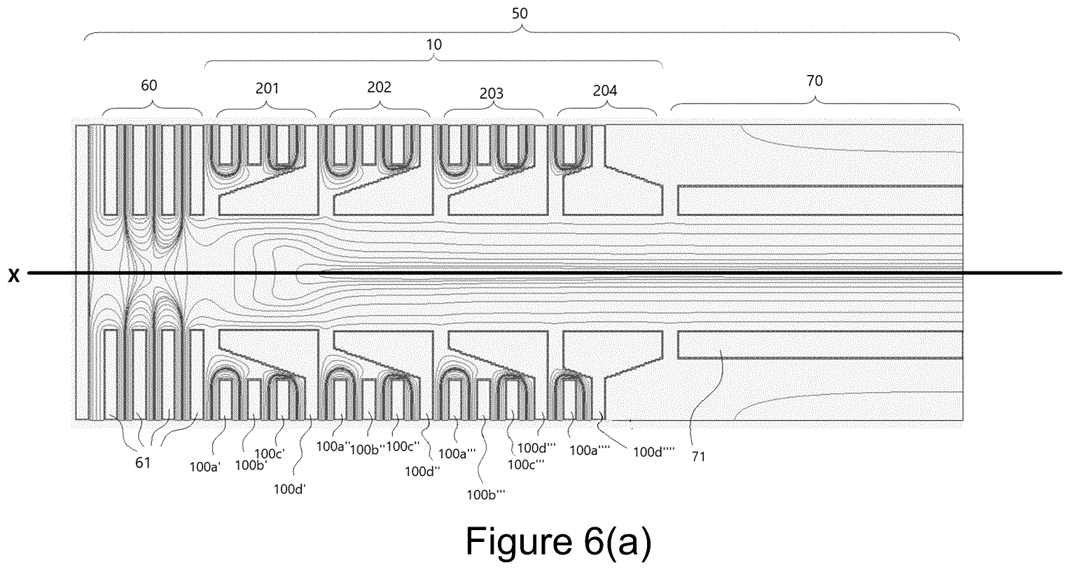

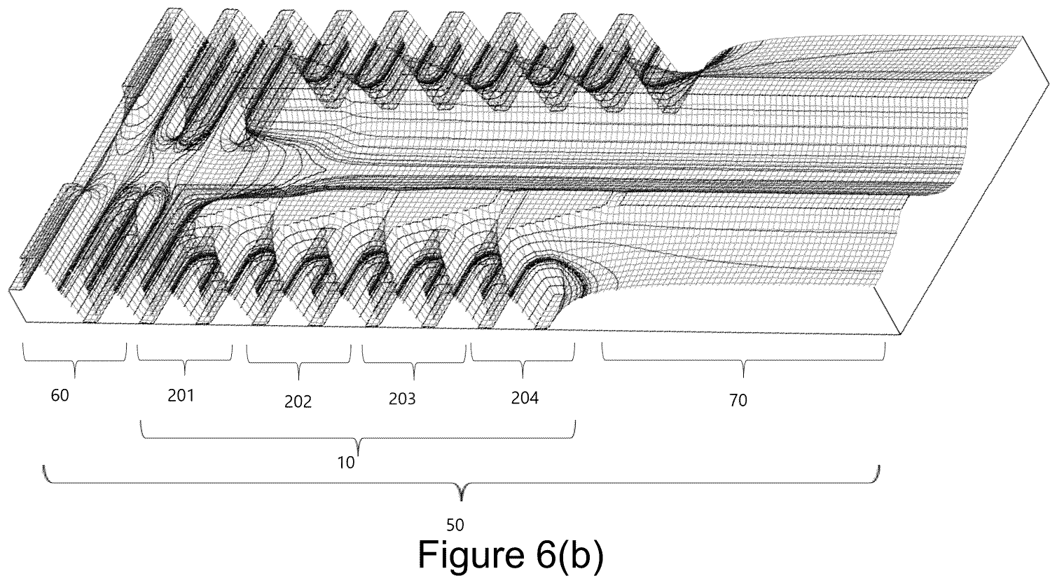

FIG. 6(a) shows equipotential lines of the RF field generated by the ion transfer assembly 50 of FIG. 5 in use where the voltage applied to the electrodes are +/−100 V, which is representative of the opposing RF voltages employed in a transducer commonly used in mass spectrometers. FIG. 6(b) shows potential energy along the ion xz-plane of the ion transfer assembly.

The potential energy diagram is in respect of a plan view of a longitudinal section of the ion transfer assembly 50. The potential energy diagram was calculated using simulations of electric fields, specifically using Simion. As shown in FIGS. 6(a) and (b), the RF field generated by the SRIG 60 having SRIG plate electrodes 61 has a wider acceptance area than the RF field generated by the downstream RF multipole ion guide 70 having longitudinally extending rod electrodes 71. As shown in FIGS. 6(a) and (b), the interface ion guide 10 of the claimed invention gradually decreases the acceptance area from the wider acceptance area of the SRIG 60 to the narrower acceptance area of the downstream RF multipole ion guide 70.

FIG. 7(a) is a part of potential energy diagram of FIG. 5 where the final plate electrode (i.e. most downstream plate electrode) of the SRIG 60 has been labelled with reference numeral 61i the second plate electrode 100b′ of the first set 201 of plate electrodes 100′ of the interface ion guide 10 has been labelled with reference numeral 100b′; the second electrode 100b″ of the second set 202 of plate electrodes 100″ of the interface ion guide 10 has been labelled with reference numeral 100b″; and the second electrode 100b′″ of the third set 203 of plate electrodes 100′″ of the interface ion guide 10 has been labelled with reference numeral 100b″.

FIG. 7(b) is a potential energy diagram showing the RF field generated by a set of SRIG plate electrodes 61. The potential energy diagram is in respect of a cross-section along the SRIG plate electrode labelled with reference numeral 61i in FIG. 7(a) (i.e. the final plate electrode 61 of the SRIG 60). The potential energy diagram was calculated using simulations, particularly using Simion. As shown by FIG. 7(b), the RF electric field generated by the SRIG plate electrodes 61, specifically the RF electric field generated proximal to the final plate electrode 61i of the SRIG 60, is similar to a regular dodecapole RF field and has a similar acceptance area.

FIG. 7(c) is a potential energy diagram showing the RF field generated by the first set 201 of plate electrodes 100′ of the interface ion guide 10. The potential energy diagram is in respect of a cross-section along the plate electrode labelled with reference numeral 100b′. The potential energy diagram was calculated using simulations, particularly using Simion. As shown by FIG. 7(c), the RF electric field generated by the first set 201 of plate electrodes 100′ of the interface ion guide 10, specifically the RF electric field generated in the middle of the first set 201 of plate electrode 100′ of the interface ion guide 10 is a regular dodecapole RF field. As shown in FIG. 7(c), the inner surface of each of the protrusions 140a′, 140b′. 140c′, 140d′ within the first set of plate electrodes 201 has the same radial distance to the longitudinal axis X and the same angular extent about the longitudinal axis X (i.e. the same width). Therefore, the primary protrusions 140a′, 140d′ and secondary protrusions 140b′, 140c′ equally contribute to the RF field generated. As shown by comparing FIG. 7(c) to FIG. 7(b), the regular dodecapole field generated by the first set 201 of plate electrodes 100′ has a similarly sized acceptance area to the RF field generated by the SRIG 60. Consequently, the SRIG 60 and the first set 201 of plate electrodes 100′ of the interface ion guide 10 generate RF fields of similar acceptance areas. As discussed above, the RF voltage applied to the plate electrodes of the SRIG 60 can be of the same frequency and/or amplitude of the RF voltage applied to the plate electrodes 100 of the interface ion guide 10. Consequently, the fringing fields between the SRIG 60 and the interface ion guide 10 are weak and so a DC electrode between the interface ion guide 10 and SRIG 60 that would otherwise mitigate such fringing fields is not required. Such a DC only electrode would typically require voltage tuning and have a higher tendency to be contaminated and in consequence give rise to charge build-up which distorts the local electric potential.

FIG. 7(d) is a potential energy diagram showing the RF field generated by the second set 202 of plate electrodes 100″ of the interface ion guide 10. The potential energy diagram is in respect of a cross-section along the electrode labelled with reference numeral 100b″. The potential energy diagram was calculated using simulations, particularly using Simion. As shown by FIG. 7(d), the RF electric field generated by the second set 202 of plate electrodes 100″ of the interface ion guide 10, specifically the RF electric field generated in the middle of the second set 202 of plate electrodes 100″ of the interface ion guide 10 is an irregular dodecapole RF field and has a reduced acceptance area compared to the RF field generated by the first set 201 of plate electrodes 100′ as shown in FIG. 7(c). As shown in FIG. 7(d), the inner surface 143a″, 143d″ of the primary protrusions 140a″, 140d″ is radially closer and wider (i.e. greater angular extent) than the inner surface 143b″, 143c″ of the secondary protrusions 140b″, 140c″ and consequently the primary protrusions 140a″, 140d″ have a greater effect on the RF field generated. The effect of the secondary protrusions 140b″, 140c″ on the RF field is localised to the secondary protrusion 140b″, 140c″, as shown in FIG. 7(d) due to its reduced width and reduced radial distance to the longitudinal axis X.

FIG. 7(e) is a potential energy diagram showing the RF field generated by the third set 203 of plate electrodes 100′″ of the interface ion guide 10. The potential energy diagram is in respect of a cross-section along the plate electrode 100b′″ labelled with reference numeral 100b′″. The potential energy diagram was calculated using simulations, particularly using Simion. As shown by FIG. 7(e), the RF electric field generated by the third set 203 of plate electrodes 100′″ of the interface ion guide 10, specifically the RF electric field generated in the middle of the third set 203 of plate electrodes 100″ of the interface ion guide 10 is an irregular dodecapole RF field and has a reduced acceptance area compared to the RF field generated by the first and second sets of plate electrodes 201, 202 as shown in FIGS. 7(b) and 7(c). As shown in FIG. 7(d), the inner surface 143a′″, 143d′″ of the primary protrusions 140a″, 140d″ is radially closer and wider (i.e. greater angular extent) than the inner surfaces 143a″, 143d″ of the corresponding primary protrusions 140a″, 140d″ of the second set 202 of plate electrodes 100″ and the inner surfaces 143b″, 143c″ of the secondary protrusions 140b″, 140c″. Consequently, the primary protrusions 140a″, 140d″ have a greater effect on the RF field generated thereby reducing the acceptance area further so that the RF field generated has a similar acceptance area to a quadrupole RF field.

FIG. 7(f) is a potential energy diagram showing the RF field generated by the fourth set of plate electrodes of the interface ion guide. The potential energy diagram is in respect of a cross-section along the electrode labelled with reference numeral 100a″″ in FIG. 7(a). The potential energy diagram was calculated using simulations, particularly using Simion. As shown by FIG. 7(f), the RF electric field generated by the fourth set of plate electrodes 100″″ of the interface ion guide 10 is a regular quadrupole RF field when RF voltages of opposite polarities are applied to adjacent pairs of the plate electrodes 100″″.

FIG. 7(g) is a potential energy diagram showing the RF field generated by the downstream RF multipole ion guide of the ion transfer assembly. The potential energy diagram was calculated using simulations, particularly using Simion. As shown by FIG. 7(g), the RF electric field generated by the downstream RF multipole ion guide is a regular quadrupole RF field when RF voltages of opposite polarities are applied to adjacent pairs of the plate electrodes 100″″. The quadrupole field generated by the downstream RF multipole ion guide is substantially the same as the quadrupole RF field generated by the fourth set of plate electrodes as shown by comparing FIG. 7(f) to FIG. 7(g).

The equipotential lines for FIGS. 7(a) to 7(g) are for +/−75 V, +/−50 V, +/−12.5 V, +/−6.25 V, 3.125 V, 1.50 V, and 0.75 V.

As demonstrated by FIGS. 6 and 7, in use, ions are received by the SRIG having a wide acceptance area, which is advantageous for receiving a wider ion beam and/or higher space charge values. The ions are focused towards the longitudinal axis X due to the RF field generated, as shown in FIG. 7(a) and may be driven along the longitudinal axis X by a DC field gradient applied across the SRIG plate electrodes 61. No DC-only electrode is provided between the SRIG 60 and the interface ion guide 10 and ions are transmitted directly from the SRIG 60 to the interface ion guide 10. Ions within the interface ion guide 10 travel through the apertures 120 in the first, second, third and fourth sets 201, 202, 203, 204 of plate electrodes 100 and are focused towards the longitudinal axis X by the RF field generated. The RF field generated has a gradually decreasing acceptance area as the RF field changes from a regular dodecapole RF field, which has a similar acceptance area to the RF field generated by the SRIG 60, to irregular dodecapole RF fields of reducing acceptance areas and finally to a quadrupole RF field. The acceptance areas are decreased by reducing the radial distance between the inner surface of the primary protrusions 140a and the longitudinal axis X and by increasing the width of the inner surface (angular extent) of the primary protrusions 140a where the primary protrusions 140a are spaced 90 degrees apart from each other and are optionally aligned at the same angular positions as the rods 71 of the downstream RF multipole ion guide 70. The ions are then transmitted directly to the downstream RF multipole ion guide 70 that generates a quadrupole RF field of substantially the same acceptance area and shape as the quadrupole RF field generated by the most downstream set of plate electrodes 100 of the interface ion guide 10. The most downstream set of plate electrodes 100 of the interface ion guide 10 employs four protrusions spaced 90 degrees apart from each other about the longitudinal axis X and at similar, preferably the same position about the longitudinal axis X as the corresponding rod 71 of the downstream RF multipole ion guide 70.

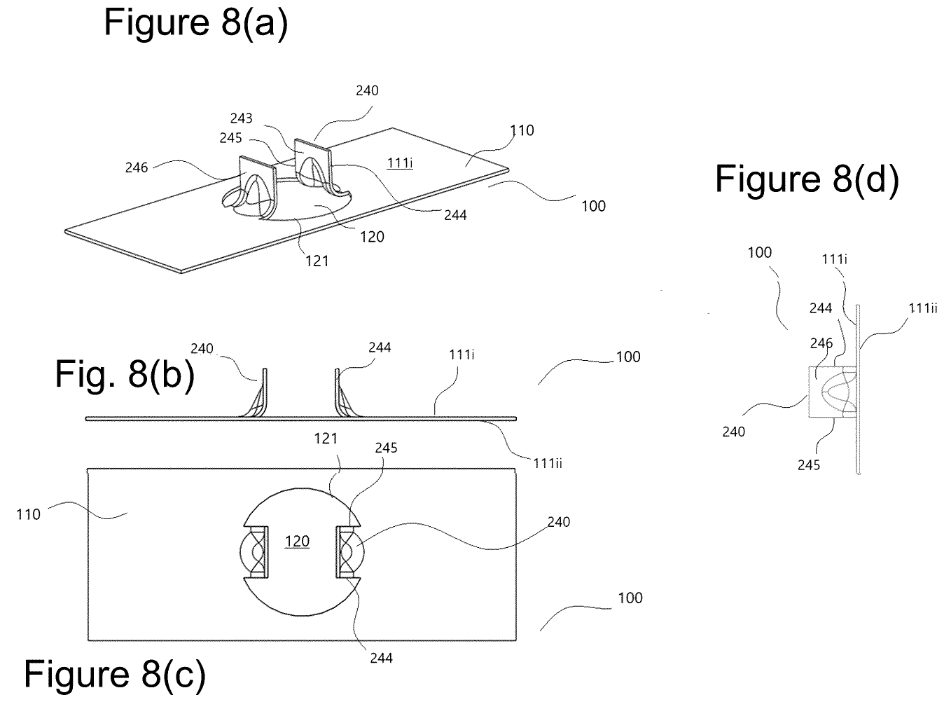

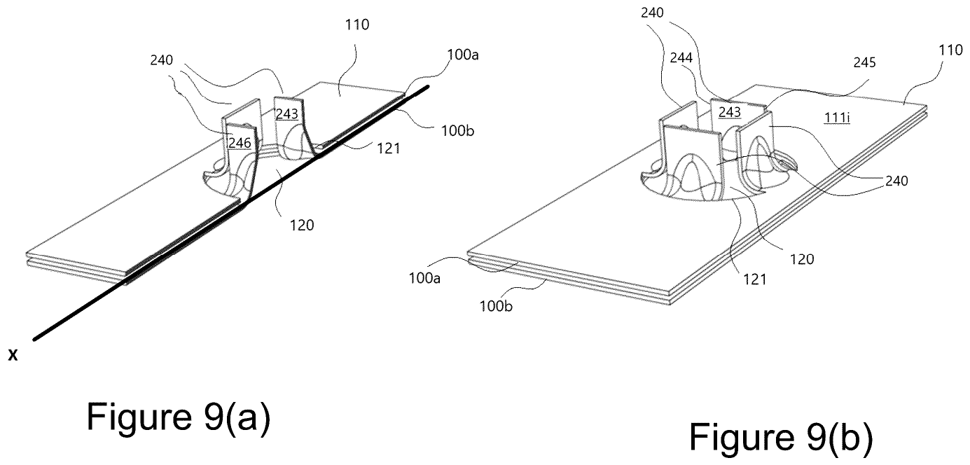

The protrusions of the plate electrode of the interface ion guide may have alternative configurations. An exemplary alternative configuration of the protrusions, labelled in this figure with reference numeral 240 is shown in FIGS. 8 and 9. As shown in FIGS. 8 and 9, the protrusions 240 may be formed as a curved sheet extending from the periphery 121 of the respective aperture 120 and bent out of the plane of the planar surface 111i of the plate 110. In other words, the curved sheet may bend through the non-zero angle to the planar surface 111i, which may be, for example approximately 80-100°, preferably approximately 85-95°, more preferably approximately 89-91°, most preferably approximately 90°. In such an arrangement, the inner surface 143′ and outer surface 146′ may be parallel to each other. In such an arrangement, the protrusions 240 may be formed integrally with the plate 110 of the plate electrode 100. For example, the protrusions 240 may be extensions of the respective plate 110 and extend from the periphery 121 of the respective aperture 120. Each plate electrode 100 may have any number of protrusions 240 as discussed above. As exemplified by FIG. 9, the plate electrodes 100 together form a set of plate electrodes similarly to the sets of plate electrodes discussed above where the protrusions 240 are arranged such that each pair of adjacent protrusions within the set of plate electrodes has a first protrusion extending from a plate electrode having an RF voltage applied thereto and a second protrusion extending from a plate electrode having an RF voltage of opposite polarity applied thereto. The protrusions 240 extend longitudinally through the apertures 120 of the plates 110 within the set of plate electrodes as shown in FIG. 9. The length of the protrusions 240 between their first and second ends 241, 242 may be such that, when the plate electrodes are assembled as a set of plate electrodes, the first ends 241 of the protrusions 240 are aligned with each other and the second ends 242 of the protrusions 240 are aligned with each other.

The protrusions 240 of FIGS. 8 and 9 are shown as having inner surfaces 243 of the same width and same radial distance to the longitudinal axis X and so would generate a regular RF multipole field. (As discussed above, the width of the inner surface 243 is between the first edge 244 and the second edge 245 of the inner surface 243). The protrusions 240 also have outer surface 246 that is parallel to and opposing the inner surface 243. Similarly to the embodiment of FIGS. 1 to 7, the number of protrusions 240 within each set of plate electrodes may be varied to vary the order of the field generated. Similarly to the embodiment of FIGS. 1 to 7, the width and radial distance to the longitudinal axis X for certain protrusions may be varied to adjust their effect on the RF field generated.

It will be understood that the embodiments described above are for the purposes of illustration only and that the invention is not so limited. The skilled reader will envisage various modifications and alternatives that fall within the scope of the claims.

For example, although in the embodiment of FIGS. 5 to 7, the downstream RF multipole ion guide has been described as having four rods configured to generate a quadrupole RF field, the downstream RF multipole ion guide may employ other numbers of rods configured to generate an RF multipole field of a different order.

Although in the embodiment of FIGS. 1 to 7, the interface ion guide employs twelve protrusions in each of first, second and third sets of plate electrodes, configured to generate dodecapole RF fields, other numbers of protrusions may be employed thereby generating RF fields of different orders. In one arrangement, the total number of protrusions may decrease sequentially for each downstream set of plate electrodes. For example, the first set of plate electrodes may contain twelve protrusions generating a dodecapole RF field, the second set of plate electrodes may contain eight protrusions generating an octopole RF field and the third set of plate electrodes may contain six protrusions generating a hexapole RF field.

In the embodiment of FIGS. 1 to 7, adjacent protrusions within a set of plate electrodes form pairs of adjacent protrusions. Each pair of adjacent protrusions has a first protrusion that is part of a plate electrode configured to have an RF voltage applied thereto and a second protrusion that is part of a plate electrode configured to have an RF voltage of opposite polarity applied thereto. Consequently, in use, adjacent protrusions have RF voltages of opposite polarities applied thereto.

In an alternative embodiment, the phase difference between the RF voltages applied to the pairs of plate electrodes may be different from 180 degrees, such as 60 degrees or 120 degrees. In other words, the first protrusion within each pair of plate electrodes may be configured to have an RF voltage applied thereto that is out of phase by at least 60 degrees from the RF voltage applied to the second plate electrode within the same pair of plate electrodes.

In an alternative embodiment, adjacent protrusions within a set of plate electrodes may be grouped into a group of protrusions containing two or more adjacent protrusions. Two adjacent groups of protrusions form a pair of adjacent groups. Each pair of adjacent groups has a first group where the protrusions within the first group are part of one or more plate electrode(s) configured to have a RF voltage applied thereto and a second group where the protrusions within the second group are part of one or more plate electrode(s) configured to have an RF voltage applied thereto that is out of phase with, for example at least 60 degrees out of phase with, the RF voltage applied to the protrusions of the first group. In a particular arrangement, the RF voltage applied to the first group within the pair of adjacent groups is 180 degrees out of phase with (i.e. of opposite polarity to) the RF voltage applied to the second group within the same pair of adjacent groups. In an arrangement where each group has a single protrusion, the RF field generated would be a dodecapole RF field. In an arrangement where each group has two protrusions, the RF field generated would be a hexapole RF field. In an arrangement where each group has four protrusions, the RF field generated would be a quadrupole RF field. In one particular example, the first set of plate electrodes may have twelve groups of protrusions, each group having one protrusion; the second set of plate electrodes may have six groups of protrusions, each group having two protrusions; the third set of plate electrodes may have four groups of protrusions, each group having three protrusions.

In an alternative embodiment, a transition from a dodecapole RF field to a multipole with a tripolar geometry may be achieved by using 12 protrusions in one set of plate electrodes. For a final multipole with a tripolar geometry, a dephasing of 120 degree of the RF amplitude may be applied. For such an alternative embodiment, n sets of 6 plate electrodes may be employed where n>1. RF voltages that are 120 degrees out of phase with each other may be applied to pairs of adjacent plate electrodes within the set of plate electrodes. In particular, the first (most upstream) plate electrode may have a first RF voltage applied thereto, the second plate electrode may have a second RF voltage applied thereto that is 120 degrees out of phase with the first plate electrode and the third plate electrode may have a third RF voltage applied thereto that is 240 degrees out of phase with the first plate electrode (and 120 degrees out of phase with the second plate electrode). The fourth plate electrode may have the first RF voltage applied thereto, the fifth plate electrode may have the second RF voltage applied thereto and the sixth plate electrode may have the third RF voltage applied thereto. In this arrangement, the primary protrusions may be spaced 120 degrees apart about the longitudinal axis and form a tripole when RF voltages that are 120 degrees out of phase are applied to adjacent pairs of the primary protrusions. The remaining nine protrusions would be secondary protrusions. The protrusions may be distributed amongst the plate electrodes so that pairs of adjacent plate electrodes have RF voltages that are 120 degrees out of phase from each other applied thereto. In one exemplary arrangement, the effect of the primary protrusion compared to the secondary protrusion may be increased along to the longitudinal axis by increasing the radial distance from the inner surfaces of the secondary protrusions to the longitudinal axis or by decreasing the radial distance from the inner surfaces of the primary protrusions to the longitudinal axis. In a further exemplary embodiment, the first, second and third plate electrodes may each have three of the secondary protrusions and the fourth, fifth and second plate electrodes may each have one of the primary protrusions to transition the RF multipole field generated to a tripolar RF field. Such a tripolar RF field may be approximately the same as the tripolar RF multipole field generated using rods.

Although in the embodiment of FIGS. 1 to 7, the interface ion guide employs four protrusions in its final set of plate electrodes configured to generate a quadrupole RF field, other numbers of protrusions may be employed and corresponding orders of RF field may be generated.

Although in the embodiment of FIGS. 1 to 7, the interface ion guide employs four sets of plate electrodes, a different number of sets of plate electrodes may be employed.

Although in the embodiment of FIGS. 1 to 7, the interface ion guide employs four plate electrodes within the first, second and third sets of plate electrodes, other number of plate electrodes may be provided within each of the first, second and third sets of plate electrodes. Each of the first, second and third sets of plate electrodes may have the same or a different number of plate electrodes. For example, one or more of the sets of plate electrodes may employ six plate electrodes.

Although in the embodiment of FIGS. 1 to 7, the interface ion guide employs two plate electrodes within the fourth set of plate electrodes, other number of plate electrodes may be employed. For example, four plate electrodes may be employed in the fourth set of plate electrodes.

Although in the embodiment of FIGS. 1 to 7, the plate electrodes of the SRIG and the interface ion guide are shown as having rectangular plates and circular apertures, plates of alternative shapes and apertures of alternative shapes are contemplated providing the aperture is centred along the longitudinal axis X of the ion transfer device 10.

FIGS. 8 and 9 employ protrusions of different configurations to those of FIGS. 1 to 7. Further alternatively shaped protrusions are contemplated providing that the protrusions have an inner surface with a length extending at a non-zero angle to the planar surface of the plate, preferably at approximately 90 degrees to the planar surface of the plate. In other words, the protrusions have an inner surface extending longitudinally, preferably through the apertures of the other plate electrodes within the set of plate electrodes. For example, the protrusions may be shaped as rods that may have a uniform cross section. The rods may be cylindrical.

1. An interface ion guide for transmitting ions from a stacked ring ion guide (SRIG) to a multipole ion guide, the interface ion guide having a longitudinal axis and comprising:
n set(s) of plate electrode(s), wherein n≥1;
each set of plate electrodes comprising two or more plate electrodes;
each plate electrode comprising a plate, the plate comprising a planar surface and an aperture formed in the planar surface for transmission of ions therethrough along the longitudinal axis, wherein the plate of each plate electrode is spaced apart from the plate of an adjacent plate electrode along the longitudinal axis; and
each plate electrode further comprising one or more protrusions, wherein each protrusion extends at a respective non-zero angle to the planar surface, wherein the protrusion(s) of each set of plate electrodes are configured to generate an RF multipole field to focus ions towards the longitudinal axis.

2. The interface ion guide of claim 1, wherein the non-zero angle is approximately 80-100°, preferably approximately 85-95°, more preferably approximately 89-91°, most preferably approximately 90°.

3. The interface ion guide of claim 1, wherein n≥2, wherein each set of plate electrodes are spaced apart from each other along the longitudinal axis, wherein a 1^{st} set of plate electrodes are upstream of an nth set of plate electrodes, preferably wherein the 1^{st} set of plate electrodes defines an ion inlet of the interface ion guide and the nth set of plate electrodes defines an ion outlet of the interface ion guide.

4. The interface ion guide of claim 3, wherein the protrusions of the nth set of plate electrodes are configured to generate an RF multipole field of a lower order than the protrusions of the 1^{st} set of plate electrodes.

5. The interface ion guide claim 3, wherein the protrusions of the 1^{st} set of plate electrodes are configured to generate a RF multipole field of the 6^{th} order and/or wherein the protrusions of the nth set of plate electrodes are configured to generate an RF multipole field of the 2^{nd} order.

6. The interface ion guide of claim 1, wherein each protrusion extends from the plate of the respective plate electrode, preferably wherein each protrusion extends from a periphery of the aperture of the respective plate electrode.

7. The interface ion guide of claim 1, wherein the protrusions of each set of plate electrodes are spaced apart from each other about the longitudinal axis.

8. The interface ion guide of claim 1, wherein each protrusion longitudinally extends at the non-zero angle to the planar surface through the aperture of at least two of the plate electrodes within the respective set of plate electrodes.

9. The interface ion guide of claim 1, wherein each protrusion extends longitudinally at the non-zero angle to the planar surface and radially inward from a periphery of the aperture of the respective plate electrode.

10. The interface ion guide of claim 9, wherein n≥3, wherein a 1^{st} set of plate electrodes are upstream of an nth set of plate electrodes, wherein the protrusions of each set of plate electrodes between the 1^{st} set of plate electrodes and the nth set of plate electrodes are configured such that a radial distance from at least one of the protrusions to the longitudinal axis is greater than the radial distance from the corresponding protrusion(s) of the upstream set of plate electrodes to the longitudinal axis.

11. The interface ion guide of claim 9, wherein n≥3, wherein each protrusion comprises an inner surface radially inward of the periphery of the aperture, wherein the inner surface has a length extending at the non-zero angle and a width extending perpendicular to the length, wherein a 1^{st} set of plate electrodes are upstream of an nth set of plate electrodes, wherein the protrusions of each set of plate electrodes between the 1^{st} set of plate electrodes and the nth set of plate electrodes are configured such that the width of the inner surface at least one of the protrusions is greater than the width of the inner surface of the corresponding protrusion(s) of the upstream set of plate electrodes.

12. The interface ion guide of claim 9, wherein each protrusion extends longitudinally at the non-zero angle to the planar surface between a first end and a second end, wherein one or more of the protrusion(s) are configured such that a radial distance from the protrusion to the longitudinal axis is constant between its first end and its second end.

13. The interface ion guide of claim 10, wherein one or more of the protrusions are configured such that a radial distance between the protrusion and the periphery of the apertures of the plate electrodes increases with longitudinal distance from the periphery of the respective aperture.

14. The interface ion guide of claim 1, wherein each protrusion is a curved surface that extends radially inward from an inner periphery of the aperture and bends through the non-zero angle.

15. The interface ion guide of claim 1, wherein the plate of each plate electrode has a thickness of between 0.1 and 1.5 mm, wherein the spacing between the plates of adjacent plate electrodes within each set of plate electrodes along the longitudinal axis is between 0.1 and 1.5 mm, preferably wherein the spacing between each set of plate electrodes is between 0.20 and 0.75 mm along the longitudinal axis.

16. An ion transfer assembly configured to receive ions from an ion source and transfer ions to a downstream RF multipole ion guide and/or mass analyser, the ion transfer assembly having a longitudinal axis and comprising:
a stacked ring ion guide (SRIG) configured to receive ions from the ion source and having a longitudinal axis; and
the interface ion guide of claim 1 coupled to and downstream from the SRIG; SRIG.

17. The ion transfer assembly of claim 16, wherein the SRIG comprises two or more SRIG plate electrodes, wherein each SRIG plate electrode comprises a plate comprising a planar surface and an aperture formed in the planar surface for transmission of ions therethrough along the longitudinal axis of the SRIG, wherein the plate of each SRIG plate electrode is spaced apart from the plate of an adjacent SRIG plate electrode along the longitudinal axis of the SRIG;
wherein the longitudinal axis of the SRIG and the longitudinal axis of the interface ion guide are aligned with the longitudinal axis of the ion transfer assembly.

18. The ion transfer assembly of claim 17, wherein the spacing between the plates of adjacent plate electrodes of the interface ion guide along the longitudinal axis of the interface ion guide is approximately the same as the spacing between the plates of adjacent SRIG plate electrodes along the longitudinal axis of the SRIG, and/or wherein a thickness of each plate of the interface ion guide is approximately the same as a thickness of each plate of the SRIG.

19. A method of transmitting ions from a stacked ring ion guide (SRIG) to a multipole ion guide using the interface ion guide of claim 1, the method comprising:
applying RF voltages to pairs of adjacent plate electrodes within each set of plate electrodes to generate an RF multipole field for each set of plate electrodes that focuses ions towards the longitudinal axis, wherein the RF voltage applied to a first plate electrode of each pair is out of phase with the RF voltage applied to a second plate electrode of the same pair; and
preferably applying a DC voltage to one or more of the plate electrodes such that a DC field that drives ions along the longitudinal axis is generated.

20. The method of claim 19, wherein the RF voltage applied to the first plate electrode of each pair is at least 120 degrees out of phase with the RF voltage applied to the second plate electrode of the same pair.

21. The method of claim 19, wherein the SRIG comprises two or more SRIG plate electrodes that are spaced apart along a longitudinal axis of the SRIG, wherein each SRIG plate electrode comprises a planar surface and an aperture formed in the planar surface for transmission of ions therethrough along the longitudinal axis, wherein the plate of each SRIG plate electrode is spaced apart from the plate of an adjacent SRIG plate electrode along the longitudinal axis of the SRIG,
wherein the method further comprises applying RF voltages to pairs of adjacent SRIG plate electrodes to generate an RF field that focuses ions towards the longitudinal axis of the SRIG, wherein the RF voltage applied to a first SRIG plate electrode of each pair is out of phase with the RF voltage applied to a second SRIG plate electrode of the same pair;
wherein the RF voltages applied to the pairs of adjacent plate electrodes of the interface ion guide are at the same frequency and/or amplitude as the RF voltages applied to the pairs of adjacent SRIG plate electrodes,
preferably wherein (i) the spacing between the plates of adjacent plate electrodes of the interface ion guide along the longitudinal axis of the interface ion guide is approximately the same as the spacing between the plates of adjacent SRIG plate electrodes along the longitudinal axis of the SRIG, and/or (ii) wherein a thickness of the plates of the plate electrodes of the interface ion guide is approximately the same as the thickness of the plates of the SRIG plate electrodes.

22. The method of claim 21, wherein the RF voltage applied to the first plate electrode of each pair is at least 120 degrees out of phase with the RF voltage applied to the second plate electrode of the same pair.
